(19) United States
(12) Patent Application Publication
(10) Pub. No.: US 2006/0248094 A1
(43) Pub. Date: Nov. 2, 2006

(54) Analysis and comparison of portfolios by citation

(75) Inventors: David Craig Andrews, Carnation, WA (US); Brian Dean Haslam, North Bend, WA (US); Susan Theresa Dumais, Kirkland, WA (US); Danielle Johnston Holmes, Bellevue, WA (US)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: Microsoft Corporation, Redmond, WA (US)

(21) Appl. No.: 11/119,323

(22) Filed: Apr. 28, 2005

(51) Int. Cl. G06F 7/00

(52) U.S. Cl. 707/100

(57) ABSTRACT

A system and method for analysis of portfolios of documents is presented. The portfolios may comprise patent-related documents, academic articles, product literature, or any other textual material. In one aspect of the invention, a user-defined classification schema is developed, and predictions for associations with classifications from the user-defined classification schema are used directly, or compared for two portfolios via an analysis computer program. In yet another aspect of the invention, the results from the automatic classifier are combined with a custom classification schema to find and rank related documents. In yet another aspect of the invention, a citation computer program compares citation statistics between entire portfolios of documents. In yet another aspect of the invention, two aspects of the invention can be combined, such that citation statistics are presented for documents that have been classified.

### RELATED APPLICATIONS

The present application relates to “Analysis and Comparison of Portfolios By Classification” (MS313398.01) simultaneously filed.

### TECHNICAL FIELD

Automated analysis of portfolios of documents is described herein. The automated analysis can compare portfolios of documents classified according to a user-defined classification schema, can find and rank related documents, and further implements a cross-citation analysis that can be used when comparing portfolios of documents by user-defined classification or otherwise.

### BACKGROUND

Many fields of endeavor have created official classification schemas, and these official classification schemas have been used to classify texts in their respective fields. For instance, United States patents are classified according to a United States Patent Classification (hereafter USPC) schema, and according to an International Patent Classification (hereafter IPC) schema.

There has also been research into automatically predicting classifications that conform with the USPC schema. For example, Larkey describes issues with using automatic classifiers to classify U.S. patents with USPC classifications in “Some Issues in the Automatic Classification of U.S. patents”. Given the large body of existing patents that are already classified according to the official PTO classification schema, and the interest by the United States Patent and Trademark Office (hereafter USPTO), this particular prior work focuses on predicting classifications taken from the standard PTO classification schema. While of interest as a labor saving device for the USPTO, the prediction of USPC classifications is of limited interest to the general public, because the public already has access to patents that have been classified according to the USPC classification schema, whether done manually by staff, or automatically by a classifier.

Moreover, while the existing USPC classification schema and IPC schemas have some significant uses, they also have some limitations and disadvantages in the information about the patent-related documents. For instance, in the official USPC classification schema, hardware and software patents are sometimes mixed into a single sub-classification, making comparison of documents in the same sub-classification problematic. Additionally, the existing USPC schema may not specify as much detail as some users wish in some technology areas, while specifying too much detail in others. Another issue is that the USPC and IPC schemas may be characterized as broad technology indexes, and some users may prefer to associate completely different classification types with patents, such as, for example, commercial products associated with patents. Additionally, since the official USPC and IPC schemas must be used to classify every patent-related document, they may include many classifications that are not relevant to certain companies or individuals. As one example, the USPC schema includes a category for “Baths, Closets, Sinks and Spitoons”, yet, this classification is not likely to be deemed useful, or desirable to a software company. In addition to the other drawbacks, the official classification schemas used to classify patents are substantially out of the control of patent applicants. A member of the public, that is not part of patent office staff, is not generally at liberty to change the official USPC or IPC schemas.

Users are free to create brand new user-defined classification schemas, so as to associate custom information not found in any official classification schema with documents, and are free to classify work according to that user-defined classification schema. While this allows users to associate interesting types and annotations with their documents, it leads to other problems that have led organizations to typically rely on existing official classifications already in place. First, the classification work, using the user-defined classification schema, may need to be performed on many documents. When performed by humans, this requires a lot of labor in order to do accurately. This classification work is a tremendous amount of effort for one organization to perform on its own documents, and the latter problem is compounded insurmountably when one considers that the classification may then need to be performed on the documents of another separate organization in order to allow comparison to take place. Second, the classification work using the user-defined classification schema may need to be performed very fast. For example, an organization may need classification of thousands of documents within a few hours so as to make a business decision. It would be extremely difficult for a small team of people to manually classify an entire portfolio of thousands of documents, using a user-defined classification schema, within a few hours.

It is notable that prediction of technology categories for patent-related documents has been performed by at least one company. For example, in a “Report on the Workshop for Operational Text Classification Systems”, Thomas Montgomery of Ford Motor Company reported use of Support Vector Machine and nearest neighbor classifiers to predict technology categories, from a taxonomy of 4,000 categories. Yet, automatic classification opens up a large number of additional opportunities and possibilities beyond evaluating technological categories for patents, and it opens up still more variations in the way in which custom schemas are created and used for prediction of classifications. In the field of patent analysis, for example, these variations lead to significant practical uses when it comes to licensing or comparison of patent portfolios.

As one example, there are many possible ways to classify patent-related documents that lead to new synergies. For example, historically patents have been classified using technology taxonomies, yet, in the area of patents, this leads to unnecessary work and error when patents are later associated with commercial products. In the case of patents, in order to find relationships between patents and commercial products, the patents have often been mapped to a technology taxonomy, and commercial products have then been mapped to the same technology schema. Where there is overlap in two items being classified by the same technology, patents are then examined in conjunction with commercial products. This double mapping method leads to potential for error in two places, in the mapping between technology and patents, and again in the mapping of technology to products. Clearly, directly finding associations between patents and commercial products is more desirable, and can reduce work and error since it involves only one mapping. In particular, a tool that predicts associations between commercial products and patents is highly desirable.

In the case of software patents, for example, still other schemas can produce synergies that traditional technology schemas fail to address. For example, if source code files are associated with patents, or binary executable components associated with patents, then patents can be tracked across projects even if source code or components are shared by multiple projects. By developing a taxonomy of source code or binary components, it is possible to track patents that are inside different projects or products, and without a double mapping, this simply isn't discernable from technology classifications. The present invention describes various methods of using custom schemas with patents that lead to advantages over simple technology classification.

It is also the case that there are ways in which a custom classification schema, and subsequent prediction of classifications can be varied tremendously, and the results have vastly different implications based on these variations. For example, in the area of patents, a common approach is to develop an all-encompassing technology classification schema that has classifications applicable to a large pool of patents shared across companies. Yet, in the area of patent license negotiation, for example, it is often desirable to specifically know just the area of overlap between two or more companies, and the goal there is not to broadly classify a broad swath of patents. For the latter example, a custom classification schema can be developed just for the documents associated with one company. By predicting custom classifications from a company-specific custom schema on the portfolio of another company, and then comparing portfolios according to that company-specific custom schema, it is much easier to see the specific patents that overlap between two companies. Interestingly, in contrast to use of an all-encompassing technology schema and training set, any patents of a competitive company that are not classified by the company-specific schema are significant, because it may indicate patents of the competitive portfolio that are concerned with non-relevant businesses.

In another approach to patent analysis, other companies have offered solutions to automatically cluster documents, such as patents and other documents, so that subsequent document comparison can take place using the automatically generated clustered groups. For example, Thomson• Delphion• offers a feature that attempts to automatically cluster a set of patents into groups. Similarly, Aureka•'s Themescape• software offers an analysis feature that can organize and present patents or other types of documents into groups superimposed on a topological map. These features can be useful, but in both cases, the user cannot define a custom classification schema by which the documents are to be classified, separated and organized. In that respect, clustering leads to different results than automatic classification, since clustering does not offer the freedom to specify user-defined classifications by which data items are associated.

The problems and limitations discussed above are applicable to portfolio comparison analysis of documents in any professional area. As yet another example, academic publications are often officially classified in journals according to keywords specified by authors. However, a university may not wish to compare the number of academic documents published by two authors, or by two universities, according to only keyword categories. For example, a university may instead wish to classify academic publications according to research departments that are within that university. This is an arduous undertaking if the university wants to compare its documents, classified by research department, with documents produced by another university, given that the other university may have research departments that are named differently. In this situation, and many others that will become evident, the present invention aids in analysis, comparison and understanding of portfolios of documents using a user defined classification schema.

Another problem in comparing sets of documents arises when the documents contain citations to other documents. For example, Tools such as Thomson• Delphion• analyze citations of patents by showing a graph of both patents that cite a single selected patent (incoming citations), and patents that are cited by this selected patent (outgoing citations). The graph is then extended by showing patents those patents cite, or are cited by. Another way this tool presents citation information is, for a given set of patents, showing the number of incoming citations each patent has and ranking the patents according to this number. Because the incoming and outgoing citations are not restricted in any way and include the entire universe of patents, no data can easily be gathered concerning the citation relationship of two separate portfolios of patents.

In an attempt to address the above problems, and other problems concerning understanding, comparison and search of portfolios, the present invention provides a flexible, fast and automated method for a user to compare and analyze portfolios of documents according to a user-defined classification schema. It presents computer programs that facilitate the analysis via portfolio comparison, related document search and rank, as well as citation analysis.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present invention applies a text classifier to a portfolio of documents that contain text content or other features in order to classify them according to an arbitrary user-defined classification schema. The automatic classification allows for later comparison analysis of the portfolios of documents. In particular, a user-defined classification schema allows for separation of documents according to categories that a user specifies, and then comparison of portfolios of documents can be compared using those categories. By converting the portfolios of documents to a desired user-defined classification schema, it allows for easy comparison of documents using classifications of choice. The invention also allows for other interesting analysis, such as cross-citation analysis, optionally within classifications specified by the user, and search and ranking of documents that may be related to subject documents.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 illustrates the components of a system and method for analysis of portfolios of documents.

FIG. 2A illustrates part of a custom hierarchical technology classification schema.

FIG. 2B illustrates part of a custom hierarchical product classification schema.

FIG. 2C illustrates part of a custom hierarchical component classification schema.

FIG. 2D illustrates part of a custom source code classification schema.

FIG. 3 illustrates a sample input file suitable for training an automatic classifier.

FIG. 4 is a component diagram illustrating use of an automatic classifier in a training mode.

FIG. 5 is a component diagram illustrating use of an automatic classifier in a prediction mode.

FIG. 6 is a sample output file from the prediction mode of the automatic classifier.

FIG. 7 is a diagram illustrating use of multiple model files when predicting classifications for documents.

FIG. 8 is a flow chart illustrating an algorithm for summarization of the number of documents associated with each custom classification.

FIG. 9A is a bar chart showing a comparison of the best predicted topmost classification for each document in two portfolios of documents.

FIG. 9B is a bar chart illustrating predictions for software components associated with documents.

FIG. 10 illustrates components for using an automatic classifier to find and rank related documents.

FIG. 11 is a flow chart illustrating the steps necessary to use an automatic classifier to find related documents.

FIG. 12A is a diagram illustrating documents in Portfolio A that directly cite documents in Portfolio B.

FIG. 12B is a diagram illustrating documents in Portfolio B that are associated with a classification, and directly cite documents in Portfolio A.

FIG. 12C is a diagram illustrating documents in Portfolio B that are associated with a first classification, and directly cite documents associated with a second classification in Portfolio A.

FIG. 12D is a diagram illustrating documents in Portfolio A that are either directly or indirectly cited by documents in Portfolio B.

FIG. 13 is a flow chart illustrating an algorithm to identify documents in one portfolio cited by specific documents in another portfolio, wherein the documents in the other portfolio are associated with a particular classification.

FIG. 14 is a bar chart showing a comparison of the number of documents cited by documents in another portfolio, wherein the documents in the other portfolio are associated with a particular classification.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in a software system, the system described is provided as an example and not a limitation. As those skilled in the art will appreciate, the present examples are suitable for application in a variety of different types of hardware or software systems.

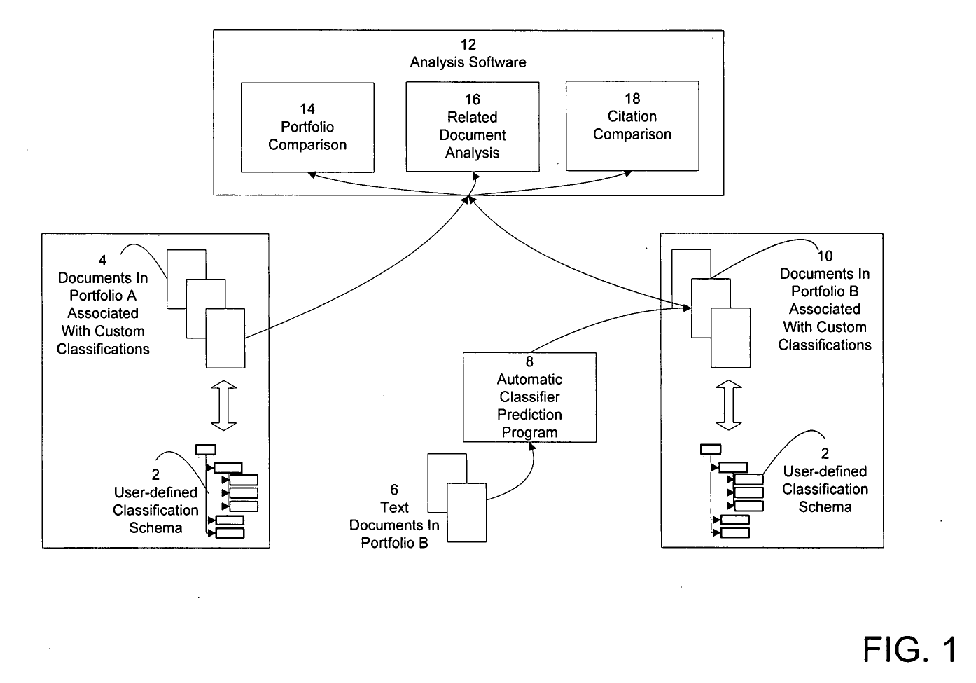

FIG.1 illustrates the components of one embodiment of a system and method for portfolio comparison and analysis, for finding documents related to another document, and for analyzing citation statistics between two portfolios. A user-defined classification schema 2 is shown, and it contains custom classifications used to characterize documents. Additionally, Portfolio A of documents 4 exists, and these documents are determined to be associated with classifications that reside in the user-defined classification schema 2. In one mode of use of the invention, Portfolio A of documents 4, where each document is associated with one or more classifications, is used to predict custom classifications associated with each document in Portfolio B 10. At this stage, Portfolio A of documents with associated custom classifications 4 and Portfolio B of documents with associated custom classifications 10 exists. The analysis program is able to input Portfolio A 4 and Portfolio B 10, and the analysis computer program contains various components, each of which is capable of generating a variety of results. A portfolio comparison component 14 can generate charts and tables that compare the documents of each portfolio associated with each custom classification. Additionally, Portfolio A of documents with associated custom classifications 4 and Portfolio B of documents with associated custom classifications 10 can be input into a citation comparison component 18 to produce statistics about citations between documents across the portfolios. Additionally, a search component 16 of the analysis program is able to search for documents that may be related to particular documents in Portfolio A 4, and can find and rank results of related documents. The components of the analysis program 12 as well as other embodiments and aspects of the invention will be discussed in more detail below.

Still referring to FIG. 1, in one embodiment of the invention, the automatic classifier prediction program 8 is built using Support Vector Machine (SVM) technology that is discussed by Dumais et al in U.S. Pat. No. 6,192,360. This classifier technology has advantages of speed and accuracy in automatic classification. In another embodiment of the invention, a rule based classifier can be used as the automatic classifier prediction program 8. Interestingly, rule-based classifiers may not necessarily require a training phase. As is readily apparent to a person of ordinary skill in the art, in another embodiment of the invention, neural networks or Bayesian networks, or any other statistical classifier technology can be used to build the classifier prediction program 8. Support Vector Machine, rule-based, neural networks, and Bayesian network text classifiers are all well known and understood by a person of ordinary skill in the art.

FIG. 1 shows documents contained in Portfolio A 4 and documents contained in Portfolio B 10. An aspect of the invention is that the documents contained in Portfolio A 4 do not need to be of the same document type as the documents in Portfolio B 10. For example, the documents in Portfolio A 4 and Portfolio B 10 can be patent-related documents, which can contain text from, without limitation, pending patents, issued patents, or patent applications, all of which can be intended for any country and written in any language. The documents may contain all of the text from the patent-related documents, including the various fields such as PTO classes, inventor names, assignee, claims, etc as well as descriptive text, or they may contain just some fields, such as descriptive text. Additionally, the documents in Portfolio A 4 and/or Portfolio B 10 can contain text from, without limitation, marketing literature, press releases, technical or non-technical whitepapers, newspaper or magazine articles, web page text, academic publications or any other documents. Also, the documents in Portfolio A 4 and/or Portfolio B 10 may comprise a mixture of types of documents. As one example, the documents of Portfolio A 4 may comprise, without limitation, a mixture of pending patents, some marketing brochure text, some press releases and some technical documentation from a user assistance manual. There is no requirement on the format of the content within the documents. The document content may comprise text or other items in any format, or may be structured by fields. As just one example, the content of a document may be structured according to an XML schema. Additionally, an aspect of the invention is that each document within either Portfolio A of documents 4 or Portfolio B of documents 10 does not need to be associated with classifications. Some of the documents may be associated with no classifications. Another aspect of the invention is that the same document may or may not exist in both Portfolio A 4 and Portfolio B 10. It is also true that the documents within Portfolio A 4 and Portfolio B 10 may be mutually exclusive, and not contain a single document that is common to both portfolios.

Referring still to FIG. 1, the user-defined classification schema 2 can comprise any number of possible classifications. An aspect of the invention is that it provides the user of the invention with the freedom to compare two portfolios of documents using a user-defined classification schema of their own choice and their own design. The user is not restricted to comparing documents using only an existing classification schema created by others. This allows a user to create sub-groups of documents using categories of choice. The classification schema can be hierarchical or non-hierarchical. The classification schema can revolve around any desired concepts. For example, it can include technology classification whereby different detailed aspects of technology are specified. In one embodiment, a classification schema related just to software technology in particular is specified. In another embodiment, the classification schema can specify products of a company, so that documents are classified and associated with specific commercial products that a company produces. In another embodiment, the classification schema can comprise commercial product categories. For example, in the field of software, product categories might include databases, operating systems, and other general product categories that contain products. The subject choice for classification schemas is limitless. In general, desirable classification schemas often include information that is not ordinarily included within documents, yet adds additional information about the document, or the relationship of the document to some other item.

Similarly, the choice for indicia that indicates a particular classification is unlimited. For example, a classification schema can use numbers such as “1” to indicate a parent classification at the topmost level, and “1.1” to indicate a child of node “1”. Equally, a classification schema can use, without limitation, the alphabet to indicate the position of a classification within the classification schema. For example, the letters “A” and “B” can be two nodes at the topmost level, while “AA” is indicative of the first child classification of classification “A”. Other embodiments can employ a classification schema that uses both numerals and alphabet, in any language, to indicate classifications.

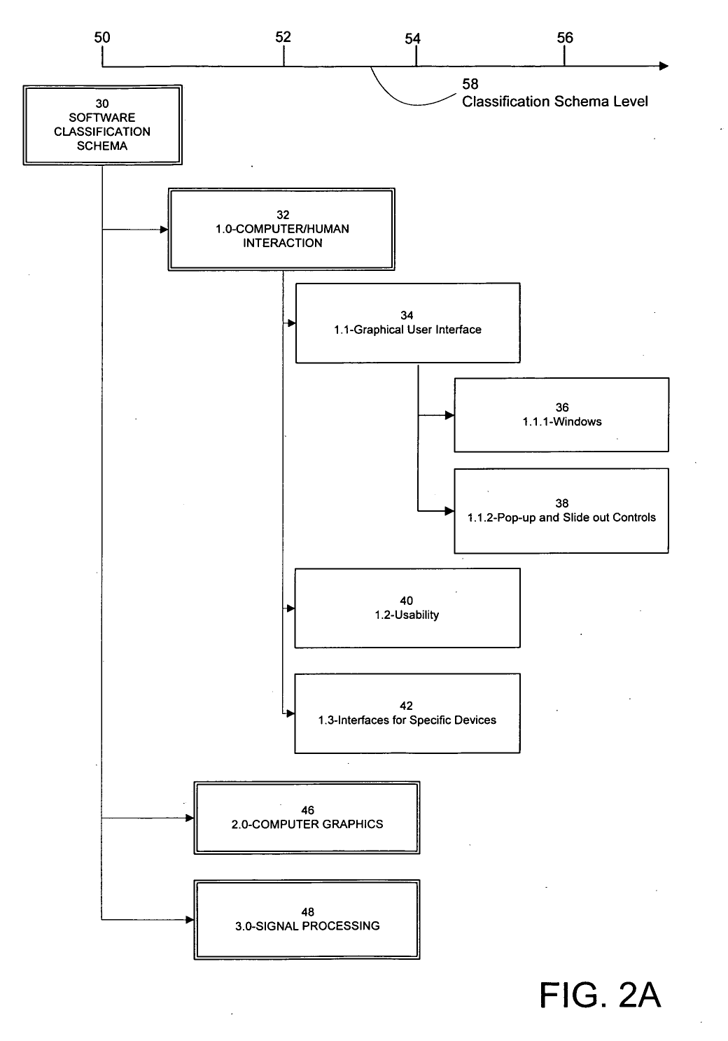

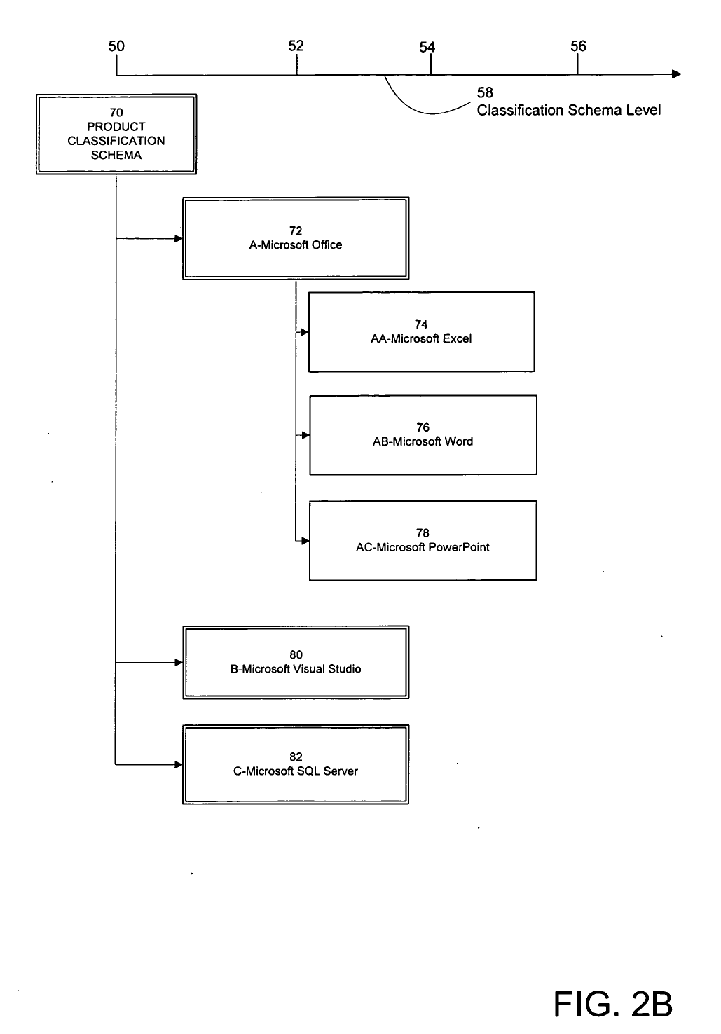

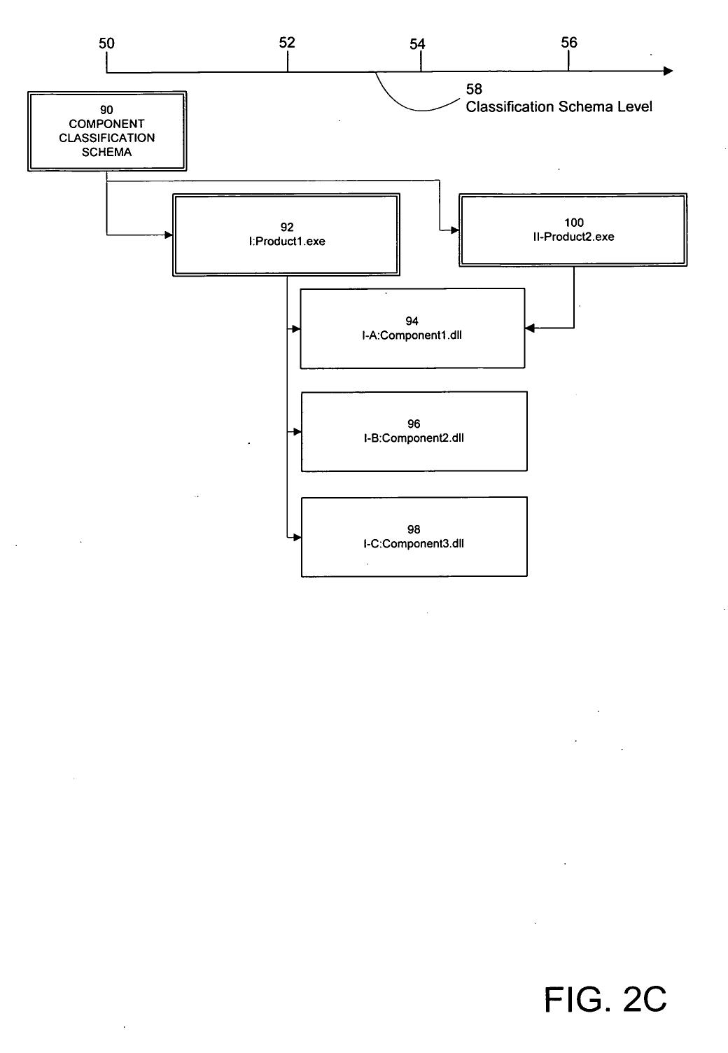

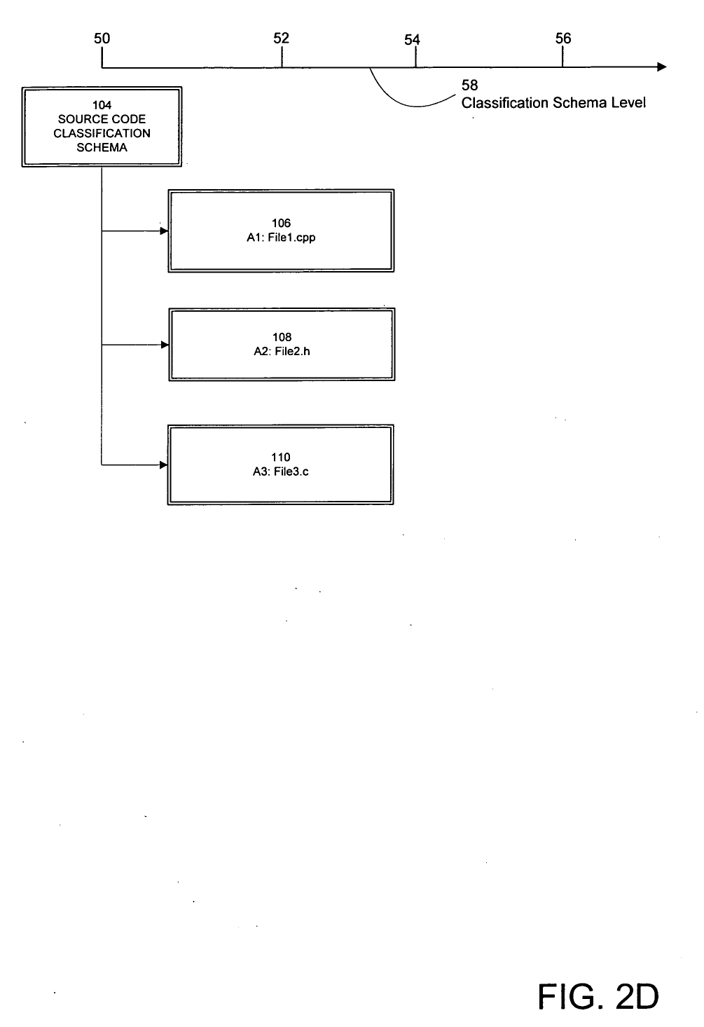

An aspect of the present invention is the freedom and ability for the user of the invention to be able to define user-defined classification schemas by which documents are to be classified and subsequently analyzed. FIG. 2A illustrates part of an exemplary custom hierarchical technology classification schema 30 by which documents may be classified. This custom technology classification schema is part of a complete schema dedicated to software technology, and in particular, allows software patents to be classified with more detail than the USPC or IPC schema. This hierarchical schema comprises nodes, with each node at a different sub-ordinate level 58 within the hierarchy. For example, 1.0-COMPUTER/HUMAN INTERACTION 32 is at level 52 of the index, and it has three child nodes. The three child nodes to node 32 are 1.1-Graphical User Interface 34, 1.2-Usability 40 and 1.3-Interfaces for Specific Devices 42, and these are at sub-ordinate level 54 of the classification schema. FIG. 2A also shows two other nodes, 36 and 38 respectively, at level 56 of the hierarchical classification schema. 2.0-COMPUTER GRAPHICS 46 and 3.0-SIGNAL PROCESSING 48 are shown at level 52. A user-defined classification schema can contain any number of nodes, and any number of levels within the hierarchy. Indeed, the full classification schema used with one embodiment of the invention has over 1600 nodes, and up to 6 sub-ordinate levels.

FIG. 2B shows part of another hierarchical classification schema 70 by which documents may be classified. This user-defined classification schema allows documents to be associated with specific commercial products created by Microsoft® Corporation. A-Microsoft Office® 72 is a parent product that comprises AA-Microsoft Excel® 74, AB-Microsoft Word® 76 and AC-Microsoft PowerPoint® 78. Also shown at the topmost level 52 of this classification schema 70 is B-Microsoft Visual Studio® 80 and C-Microsoft SQL Server 82. FIG. 2B does not show the full product line of Microsoft®, but it illustrates the structure of a product taxonomy that can be used to classify documents according to specific commercial products. As is readily seen by a person of ordinary skill in the art, a classification schema can be used to classify any type of document. For example, if a press release is associated with news about Microsoft Word®, then the press release might be associated with classifications A-Microsoft Office® 72 and AB-Microsoft Word® 76. When a child classification is applicable, it is a prerogative of the user whether documents are associated with both a parent classification and a child classification, or just a child classification.

FIG. 2C shows part of a custom hierarchical classification schema 90 that includes software components. One purpose of the illustration of this custom classification schema is to show that custom schemas do not always have to obey the same rules of structure as other schemas. For example, this hierarchical classification schema is structured differently than the user-defined classification schemas shown in FIG. 2A and FIG. 2B, because in the user-defined classification schema of FIG. 2C, any node may have more than one parent. For example, two software components Product1.exe 92 and Product2.exe 100 are depicted. One assembly Component1.dll 94 is depicted as a child of Product1.exe 92 and Product2.exe 100. For this particular user-defined classification schema, it indicates that Component1.dll is shared by two separate programs, i.e. both Product1.exe 92 and Product2.exe 100 load Component1.dll 94 and use the functions therein. FIG. 2C also shows two nodes, 96 and 98 respectively, that share the same parent node of Product1.exe 92. The component classification schema illustrated in FIG. 2C can be used to associate software executables with documents pertaining to those executables. For instance, one use could associate executables with technical documentation concerning those executables. Another use could be to associate patents that describe particular algorithms that are used inside an executable. The classification schema depicted in FIG. 2C allows patents to be associated with executables or components, and therefore allows tracking of patents across different projects or products.

FIG. 2D shows part of yet another user-defined classification schema 104. This user-defined classification schema 104 contains names of software source code file names. This particular part of the user-defined classification schema is flat—i.e. the nodes at level 52 have no children. One purpose of the classification schema illustrated in FIG. 2D is to show that classification schemas do not need to have a hierarchical structure. FIG. 2D depicts File1.cpp 106, File2.h 108 and File3.c 110 as nodes with the user-defined classification schema 104. One exemplary use of this user-defined classification schema 104 is again to classify patent-related documents with the source code classifications; so that a relationship between patents and source code that implements patented software can be established.

There are many possibilities for additional user-defined classification schemas. Notably, it is possible to create hybrid user-defined schemas that mix a variety of concepts. As just one example, a hybrid schema that includes product classifications, technology classifications, source code classifications could be created. Indeed, hybrid classification schemas enjoy an advantage since a user performing classification of documents only needs to use one schema when deciding applicable classifications to apply to a document. A second advantage of hybrid schemas is that they can express relationships between different concepts. For example, a commercial product, could include a variety of technology classifications as child nodes, and could include the source code files that make up the product (in the case of software), or the parts that make up a product (in the case of a mechanical or chemical product).

Other classification schemas are also possible. For example, a product categories schema can comprise abstractions of products. In the case of software, product categories may include such items as Databases, Operating Systems, etc. Another idea for a classification schema could include the version of a commercial product with which a document is associated. Still another idea could be the division or product unit of a company that created the document. In the area of non-software, a user-defined classification schema can be created around mechanical parts. For example, a car manufacturer can create a user-defined classification schema containing the individual mechanical parts that make up a car. The manufacturer could then associate classifications from the user-defined classification schema with press releases, or patents related to the mechanical components, or other documents of interest to the car manufacturer. Additionally, a user-defined classification schema can combine unrelated items into one classification schema such as a combination of a mechanical parts classification and a software component schema where some parts of the schema may have no relationship to other parts of the schema. A user-defined classification schema can be particularly useful when associating information not normally included inside of the document.

Once a user-defined classification schema has been created, a user must decide how to apply the classifications within the user-defined classification schema to documents. There are at least two ways to do this. The first way is for humans to decide actual classifications that are applicable to the documents, and record associations between the documents and applicable classifications. The second way is to employ a computer program to predict appropriate classifications from the classification schema for each document. Notably, use of an automated computer program to predict classifications becomes more accurate if there is a large body of work that has already been accurately classified, and a computer program often “trains” on the large body of existing work that has been classified already. As such, a hybrid approach of classifying documents can also take place, whereby documents are first classified by humans, and then other documents can then be classified by use of a computer program. For example, a portfolio of patents owned by a company can be used as a training set. Similarly, all the documents associated with a particular inventor can be used as a training set. In essence, there are limitless number of choices for the set of documents to use in training and the choice of documents to use in prediction, but the choice has a profound impact on the quality and meaning of the prediction results. The description below relates to use of an automatic classification system for prediction of classifications.

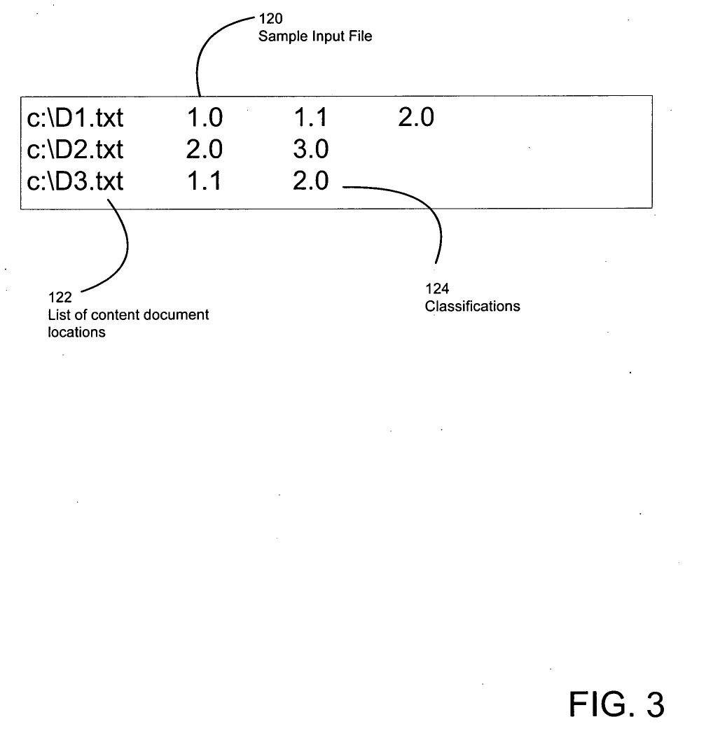

Automatic classification software can be used in conjunction with portfolios of documents associated with entities in order to allow accurate, quick and easy comparison of any portfolios of documents using classifications of choice. In one example, FIG. 3 illustrates the contents of a sample input training file 120 that can be used with one embodiment of a computer program for training an automatic classifier. On the left side of the example file is a list of the location of content documents 122. Adjacent to each content document location is a tab delimited list of custom classifications 124 that are associated with the corresponding document. Notably, the classifications 124 are shown as numbers, but they can be any alphanumeric identifier. In one mode of use, the classifications 124 of the documents within the input file 122 were decided by a human as being most appropriate for the document. The list of locations of content documents 122 can refer to, without limitation, any document. The document may also contain other information besides text. In another mode of use, the classifications can be derived from other automated systems. The training input file can be a list of the locations of any documents containing text, such as, without limitation, academic articles, technical whitepapers, marketing literature, press releases, or patent-related documents. The list of locations of documents 122 shows local disk drive locations, but the content locations can be specified as Uniform Resource Locators, as remote file share locations, or in any format that is commonly understood to be a unique location. The input training file shown in FIG. 3 is suitable for an embodiment that extracts features to be used for classification from content documents that are listed in the training file. In another embodiment, rather than use a training input file listing other content documents, an automatic classifier can just directly input content to a classifier. In yet another embodiment, an automatic classifier can directly receive features or input content from a database, or from some other computer program. In the latter embodiment, the computer program generating input to a classifier may be local or remote.

In the example training input file shown in FIG. 3, the locations of content files were specified. In this exemplary case of specifying locations of content documents, the features can be extracted by the classifier from key words or phrases found inside content documents. However, many possibilities exist for methods in which a classifier receives features for which it is to determine classifications, in training or prediction mode. For instance, in the example of specifying locations of patent-related documents, fields such as PTO classifications, IPC classifications, or filing dates may be distinguished from the general patent-related descriptive text, and input as separately labeled features to a classifier. One mechanism of input of features could be key value pairs, where a key is the name of a field (for example, “PTOClass”), and the value of the field is input into the classifier. In the latter examples, feature values are found inside the content of documents, and so these features may be considered internal. However, features input into a classifier can also be generated from external metadata associated with classifications. As just one example, if a company associated the internal research department of an inventor with a patent-related document, then that could be an external feature, since the value is external to any text within a document, that may aid a classifier in training and prediction. Both external and internal features may be included as input in training and prediction mode, and they may be input into an automatic classifier via a file, from a database, via memory sharing, via redirection, via a network, or via any computer-related means.

The number of classifications appropriate for each file is unlimited and left to the user. It can be zero classifications, which would indicate that no existing classification is appropriate for that file, or it can be one or more classifications, indicating that multiple attributes are appropriate for the document.

Still referring to FIG. 3, a training input file may have many content files listed. As just one example, forty thousand or more content documents may be specified. The invention is easily scalable to train or predict for any number of content documents, from just one content document up to and including many millions of content documents.

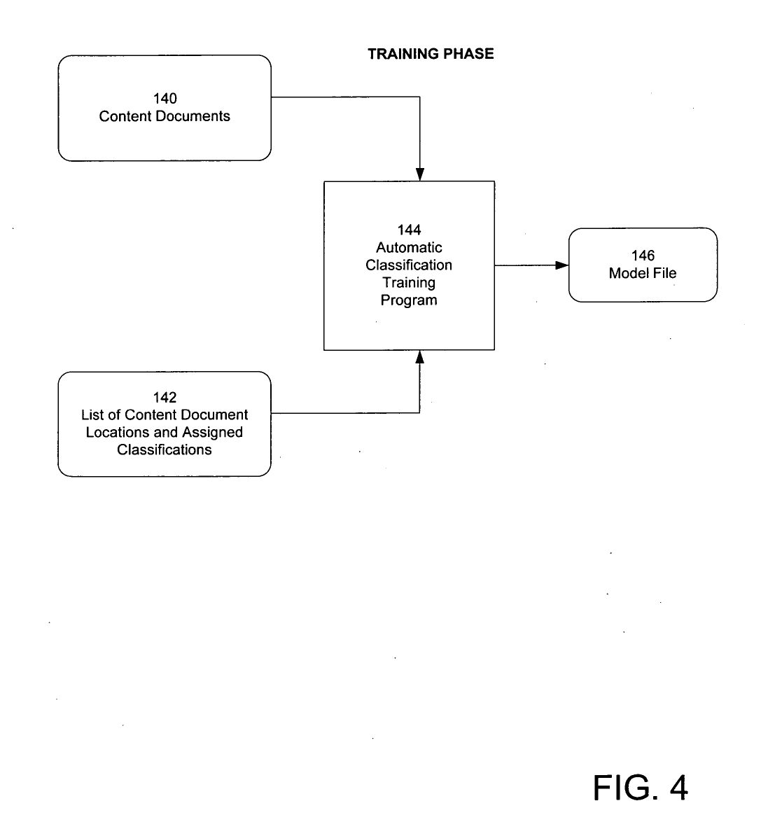

FIG. 4 shows a training mode phase of using an automatic classification computer program. A list of the locations of content documents with associated classifications 142 is input into the classification training program 144. In one embodiment, the list of documents with associated classifications 142 was formatted according to FIG. 3, described earlier. This list of documents 142 contained the locations of the content documents 140. In one embodiment, the classification training program 144 reads each location of a file from input 142, then reads an actual content file 140. In one embodiment, using a classifier based upon Support Vector Machine (SVM) technology, the training program calculated the relevancy of keywords or phrases inside of the content and calculated a weight suitable for each keyword or phrase, wherein the weight associated with the keyword or phrase was indicative of the relevancy to the classification. The model file 146, output by the training program 144, contains information that can be used by a prediction program to generate the classification appropriate for other content. In one mode of use, the method presented in U.S. Pat. No. 6,192,630 was utilized for classification.

While FIG. 4 illustrates a training phase used to create a model file that aids in prediction of classifications for content, a training phase is not necessary to use with every type of classifier. Some classifiers, such as certain rule-based classifiers, may not require a training phase in order to predict classifications. For example, a prediction program can predict a classification based solely on the presence of a keyword or phrase within content, where that same keyword or phrase also appears in the classification schema. As such, in one embodiment of the invention, a training phase is not needed, and a model file need not be created.

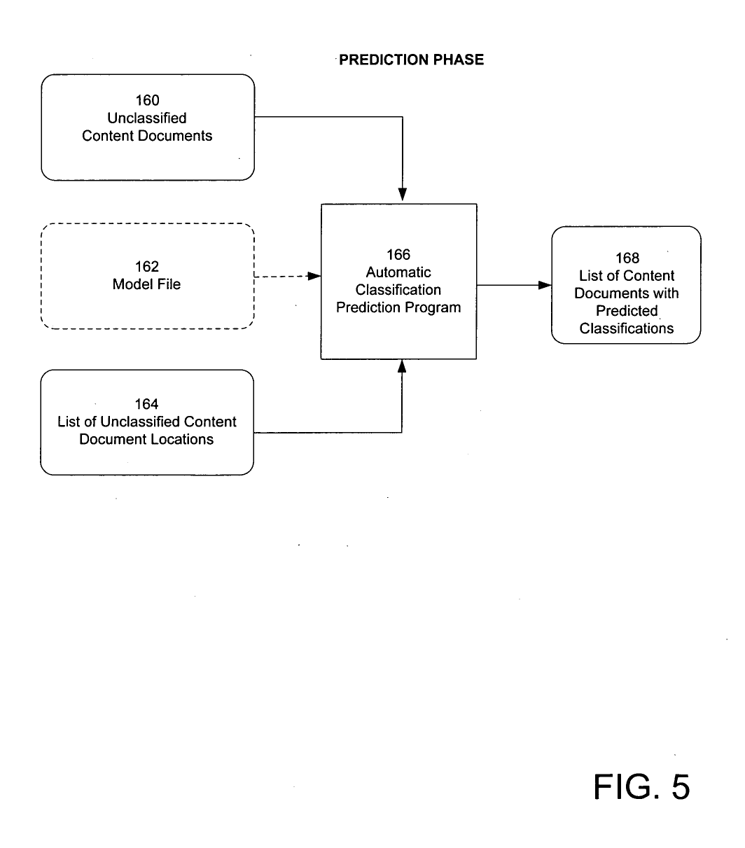

FIG. 5 illustrates the components used in the classification prediction phase of documents. In one embodiment, a list of documents 164 was provided, and each line of this file specified the location of each content document for which classifications, according to the user-defined classification schema, were desired. The location of each content file could be a local file system location, UNC network path to a file, URL or URI, or any file path that is accessible to the automatic classification predictor 166. The actual content documents 160 are shown as an additional input. For use of the invention with a Support Vector Machine (SVM) classifier, the model file 162, that was generated as the output of the training phase (see FIG. 4), was also provided as an input to the automatic classification prediction program 166. The model file 162 is shown with a dotted line to indicate that an automatic text classification prediction program 166 may not require a model file 162 as an input.

As discussed with regard to the training phase, many possibilities exist for methods in which a prediction classifier program receives features for which it is to determine classifications. While FIG. 5 illustrates use of internal features obtained from content documents (i.e. key words or phrases found within text), both external and internal features may be included as input in prediction mode, and as before, they may be input into the prediction program via a file, from a database, via memory sharing, via redirection, via a network, or via any computer-related means.

Notably, using an SVM classifier, it was also possible to specify a threshold statistical probability level, and the automatic classification prediction program did not output any classifications for which the calculated statistical probability of the classification being correct was less than the desired threshold level. In one embodiment, the threshold level could be specified between 0.0 and 1.0 inclusive. A classifier may or may not include the ability to specify a threshold statistical probability, and embodiments of the invention may have different ways to specify the input content to be classified, and different ways to output classifications associated with the input content. Similarly, classifiers can have many ways to specify a likelihood that a classification is correct, and the likelihood does not need to be a probability. For example, in another embodiment, it could just be a relative weight, using any numerical scale, that signifies how accurate a classification is deemed to be relative to other classifications. As yet another example of a likelihood, a likelihood could be a general assessment of the accuracy of a classification, such as “High”, “Medium” and “Low”. Also, using these likelihoods, there are various methods of a classifier or other computer software actually making a determination that a classification is associated with content (or a document containing content). For example, a classifier may only determine that a classification is associated with content if a predicted classification has a probability greater than a threshold probability specified by a user of the classifier. As one alternative, a classifier may determine that a classification is associated with content if a classification is predicted, regardless of the probability.

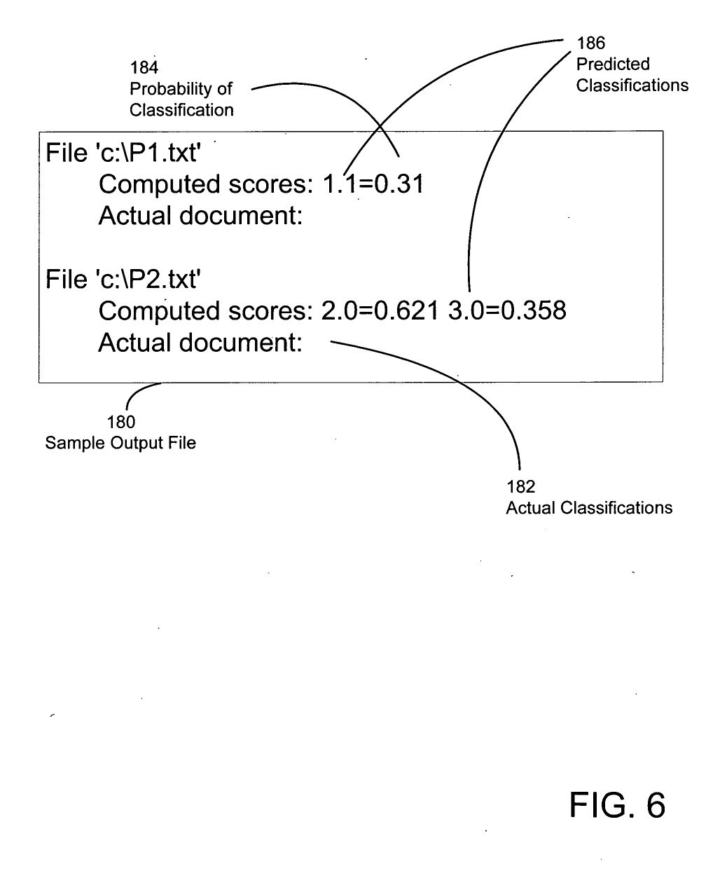

FIG. 6 illustrates a sample output file 180 from a computer prediction program used in one embodiment of the invention. The sample output file 180 lists two content documents. Beneath each file name are predicted classifications 186 and any actual classifications 182 associated with each content document. The actual classifications 182 contain any actual classifications that were previously associated with the content document, and were listed in the input file to the computer prediction program. The sample output file 180 shows no actual classifications, which indicates that the input file contained no actual classifications previously associated with the documents. The latter situation was common since classification predictions are often desired for documents for which no custom classification data exists. In one embodiment, the predicted classifications 186 were output within a pair of values. Each classification prediction was associated with an estimated statistical probability 184 of that prediction being correct. In one embodiment, the classifier generated probabilities between 0.0 and 1.0 for each classification it associated with a document. The classifier generated zero, one or multiple classification predictions 186 for each document. As is readily appreciated by a person of ordinary skill in the art, the format of the output of an automatic computer classification prediction program can change significantly, but the fundamental role of the prediction program is to output classifications that are associated with content, or with documents containing content.

The preceding description is suitable when one model file is used with prediction of classifications for content, but it is also possible to create multiple model files to aid in more accurate prediction of classifications for hierarchical classification schemas. In order to create multiple model files, a training phase can be performed for each separate classification. As an example, for classification “1”, a training input file can be created that lists all the content documents, but adds the classification “1” for the content documents associated with “1+ or any child classification of “1”. No classification is associated with any document not associated with “1”. For classification “2”, a second training input file is created that lists content documents associated with classification “2” as well as any child classification of “2”, but lists all the other documents as associated with no classifications. This is performed in the same way for each topmost classification. The training phase is then performed once for each topmost classification, using the respective input files described above for each topmost classification. This generates a model file for each topmost classification.

After a model file has been generated for each topmost classification, a model file for each child classification can be created. For example, for child classification “1.1”, a training input file is created that lists all the content documents that have any classification including or under parent classification “1”. This particular input file lists the documents classified as “1.1” as being associated with “1.1”, and the other documents (e.g. classified as “1.2”, “1.3”, etc) are listed as having no classifications. Similarly, for child classification “1.2”, a training input file that lists all the content documents that have any classification under parent class “1” are included, but classification “1.2” is listed next to those documents associated with “1.2”, and no classification is listed next to the other documents. This is repeated for each child classification, and a model file is created based on running the training phase for each child classification. This procedure of repeating the process of creating training files suitable for a particular classification can continue recursively through the user-defined classification schema, up to any level within the schema. It is also possible to use this process to selectively create model files just for certain classifications within the schema that are of particular interest.

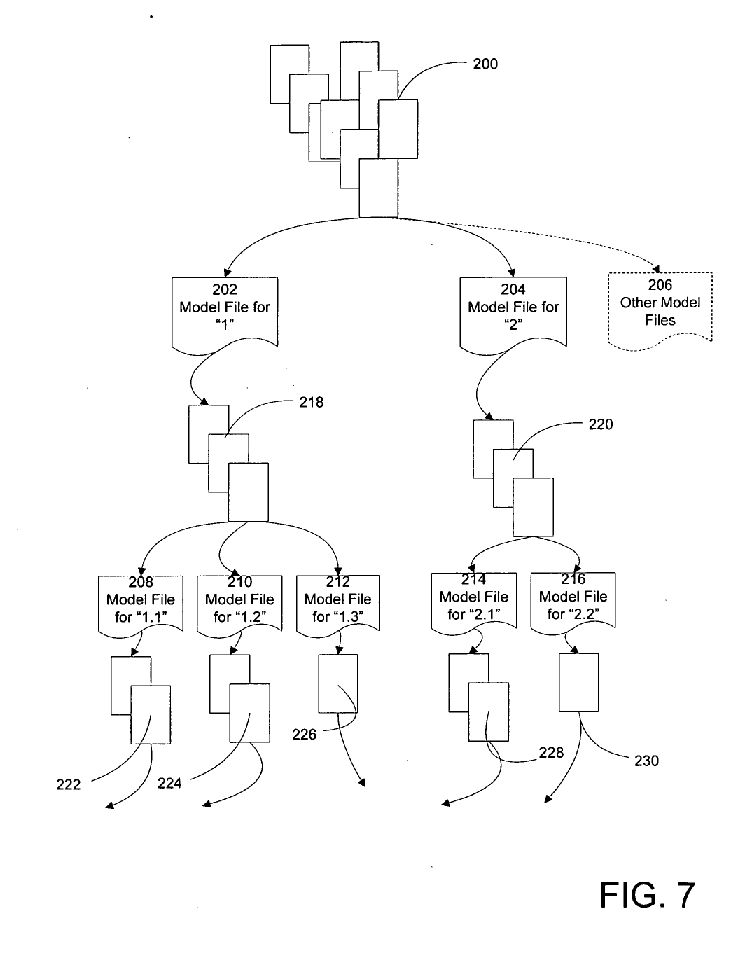

Having created a model file for each desired classification, the method of prediction illustrated by FIG. 7 can be used. A list of uncategorized content documents 200 is given as an input to the computer prediction phase along with model file 202, which is the file created specifically to identify classification “1” documents. This step produces a subset of documents 218, wherein it is determined that each content document is associated with classification “1”, or a child classification of “1”. Similarly, the prediction phase is run with input 200 and model file 204, and this step produces a subset of documents 220, and each content document in this subset of documents is predicted to be associated with classification “2”, or a child classification of “2”. The input files 200 can also be run with any other model files 206 to obtain subsets of documents associated with each topmost classification. Referring now to the set of content documents 218, each of which are associated with classification “1”, the prediction phase is run with model file 208, associated with classification “1.1”, using only those documents 218 as input. The output is a set of files 222 that is associated with classification “1.1”. Similarly, the prediction phase is run with model files 210 and 212 respectively, to identify documents associated with “1.2” 224 and “1.3” 226 respectively. In the same way, input documents 220, which are files associated with classification “2”, can be run with the prediction phase and model files 214 and 216 respectively to identify two sets of documents, 228 and 230 respectively, associated with classifications “2.1” and “2.2” respectively. This can be repeated so as to predict subsets of documents associated with any child classification, at any level within a classification hierarchy.

Another method of hierarchical training and prediction can be to perform two steps of classification. A first pass would run a classifier (in both training and prediction modes) with certain fields as features in order to predict an entity with which documents are associated. For example, for patent-related documents, features useful for a classifier to identify an associated entity could include Assignee field values and Inventor names. After the classifier has trained or predicted on the entity associated with documents, entity specific features can be used in conjunction with the automatic classifier in order to break up the portfolio into categories. For example, in the case of patent-related documents, descriptive text of the patent-related document or external metadata created by an entity may be used as input features to a classifier in order to classify the documents by category.

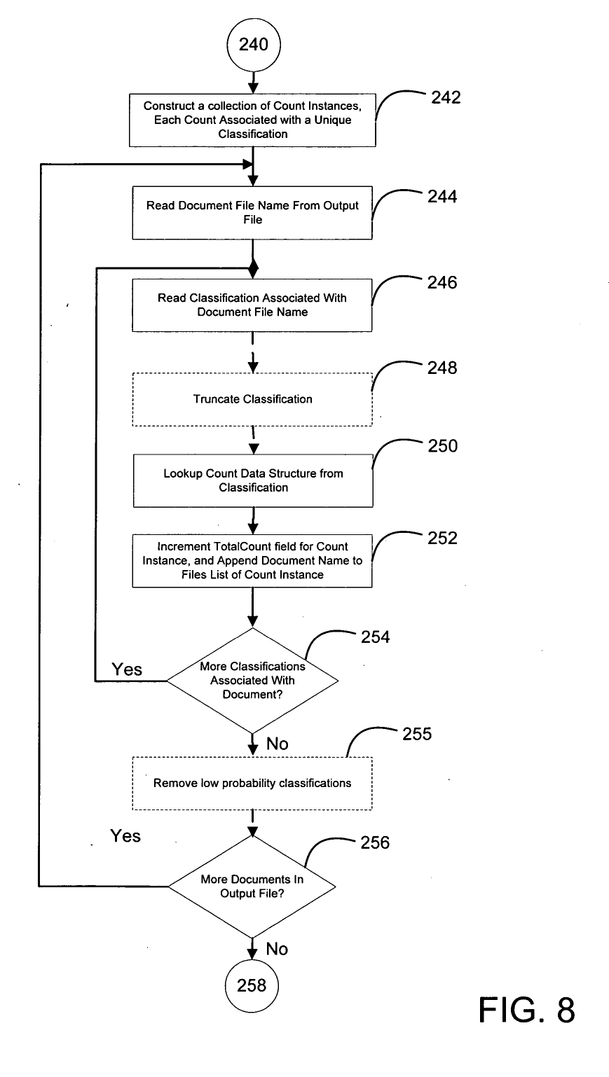

Having described methods in which an automatic classifier can be used with a user-defined classification schema to predict classifications associated with any content, it remains to be shown ways in which content documents and portfolios of content documents can then be analyzed. One method is to compare two or more portfolios of documents using custom classifications that are defined by the user of the invention. FIG. 8 is a flowchart of an algorithm to compute the total number of documents determined to be associated with each classification for a portfolio. The algorithm can be repeated for one or more portfolios. This algorithm takes place in portfolio comparison software that is part of the analysis computer program. The comparison program allows two or more distinct portfolios of documents to be compared for the number of documents that are determined to be associated with any custom classification taken from a user-defined classification schema. Notably, the algorithm can be used to calculate the total number of documents determined to be associated with actual classifications assigned by humans, or the total number of documents determined to be associated with predicted classifications assigned by a computer program. Step 240 represents the start of the program, and the program is started after two portfolios have been classified according to a user-defined classification schema.

In one embodiment of the portfolio comparison analysis program, a ‘Count’ data structure is defined. The data structure contains a Classification field, of type string, used to hold a single classification. The Count data structure also contains a TotalCount field, of type integer, and that is used to maintain a number of documents that is associated with the single classification. The Count data structure also contains a List collection field, and the List collection field is used to store a collection of all the locations of content documents associated with the classification.

In this embodiment of the portfolio analysis comparison program, a collection of instances of the Count data structure (hereafter “Count”) is created in step 242, and each Count instance is accessible using the classification as a key. As is readily appreciated by a person of ordinary skill in the art, many collection types are available in programming libraries. For example, the HashTable type available in the Microsoft® .Net Libraries allows for an object to be placed into the HashTable and accessed quickly via a key. In step 244 the computer program reads the path to the first content document that was determined to be associated with a classification. In step 246, the portfolio comparison program reads a classification associated with the document. Step 248 is shown with a dotted line to indicate that it is optional. This optional step truncates the classification that is read from the file down to a desired number of significant digits. For example, classification “1.1.1” can be truncated down to the most significant digit “1”. This allows the totals and documents associated with child classifications to be rolled up into the parent total. In the latter case, it allows for a later summary comparison of the number of documents in each parent classification. Optional step 248 may be skipped in order to obtain totals for each and every possible classification. Step 250 then takes the classification, (whether or not it has been truncated by optional step 248), and retrieves the corresponding instance of the Count data structure from the collection of Count instances. Step 252 shows that the TotalCount field is then incremented for that instance of the Count instance, and the path to the text file is added to the List collection member of the Count instance. In step 254, the comparison computer program checks for more classifications associated with the document, and if it finds any, it loops back to repeat steps 246, optional 248, 250 and 252 for that classification. This iteration continues until all the classifications associated with the document have been processed. After the program detects that no more classifications are associated with that document, the program can execute optional step 255. Optional step 255 allows for removal of low probability classifications in the case where classifications have been predicted and each classification has a probability associated with it. This can take at least two forms. In one form, optional step 255 can simply remove classifications for which the probability is below a threshold value. The threshold value can be specified by the user or coded into the software. In another form of usage, optional step 255 can remove all the classifications associated with the document except the highest probability classification. The latter step of removing all classifications except the highest probability classification is particularly advantageous if one wants to compare portfolios of documents, and one only wants to see a maximum of one classification associated with each document. Allowing only one classification per document allows for a more straightforward comparison of portfolios since the number of classifications is never more than the number of documents. In cases where more than one classification can be associated with a document, portfolio comparison can lead to confusion about how many classifications are appropriate for each document and whether one portfolio has received an unfair number of classifications per document than the other portfolio. The latter step of choosing only the highest probability classification can be advantageous because it circumvents any confusion over having more than one classification associated with each document. Step 255 is optional, and the program can omit the step altogether so that all classifications associated with a document are utilized. The program then executes step 256 which detects if there are more documents listed in the output file. If there are more documents, the program loops back to before step 244, reads the next document, and then proceeds to examine the classifications using steps 246, optional 248, 250 and 252 as before. At the end of the flowchart, in state 258, the program has obtained a total count of the number of documents associated with each classification, and a list of each document associated with each classification. If optional step 248 is included, then at the end of the program in state 258, the results for the child classifications are rolled up into the parent classification. For example, in the latter case, the documents associated with classification “1.1” may be rolled up into the list associated with the Count instance for “1”, and the number of documents associated with “1.1” may be included in the TotalCount field associated with the Count instance for “1”. If optional step 255 was included, then in one form, each document has a maximum of one classification associated with it, and it is the classification with the highest probability for that document. In another form, optional step 255 just removes classifications that have predicted probabilities below a threshold value.

The flowchart in FIG. 8 may be used to calculate statistics about actual or predicted classifications (although optional step 255 may only be used with predicted classifications), and can be performed on each portfolio of documents that have been classified via a user-defined classification schema. This allows for various possible comparisons between portfolios of documents. One comparison is to compare actual classifications of one portfolio of documents that have been classified according to a user-defined classification schema by humans; with predicted classifications of a competitive portfolio of documents. For example, suppose a company has created a user-defined classification schema for a first patent portfolio owned by that company, and employed humans to classify each patent using classifications from the company-specific custom schema. The company then wishes to compare the patent-related documents that the company has in each classification with the patent-related documents that another competitive company owns, using classifications from the classification schema associated with the company. The training is performed using the first portfolio of the company, and then classification prediction is performed on the patent-related documents of the other competitive company. In that case, the flowchart described in FIG. 8 can be used to generate statistics about actual classifications of the company's portfolio, and used to generate statistics about the predicted classifications of the other competitive company's portfolio.

It is notable that other embodiments of analysis software can count or compare other items besides the number of documents associated with each classification. For example, it is possible to generate a profile of the documents associated with an entity by calculating other statistics, such as the most common classifications present in a portfolio, or simply identifying the distinct classifications present or not present in a portfolio. Alternatively, scores could be computed to be more sophisticated within categories. As just one example, if a classifier emits probabilities with each classification prediction, a computer program could add up the likelihoods of predicted classifications in order to generate a sum for each particular classification. For a portfolio of documents, the latter method may create a total that is more proportional to a classification.

There are also methods to refine the portfolio of content documents used to train for automatic classification. For example, when training on a portfolio of patent-related documents related to a specific company, one method removes inventor names from the document content before running the training phase with those documents. A reason is that the same inventor names are not likely to be contained in the text of the documents for which predictions are sought. This method can be extended further by removing any field values that are specific to an entity. In the case of patent-related documents related to a company, another field value that may be useful to remove is the assignee. By pre-processing the training documents, and removing anything specific to a company or other entity, the pre-processing method reduces the chance of keywords or phrases that are specific to the entity appearing as features used by the classifier.

Another method of portfolio comparison is to compare predicted classifications for two portfolios of documents. One exemplary use is when a company wishes to compare the patent-related documents that two competitive companies have associated with each classification, using the user-defined classification schema. In that instance, the prediction phase can be run on the portfolio of patents owned by both companies, and the analysis program described by FIG. 8 used to find totals and documents associated with each custom classification. Since the classification prediction can be performed for both the first portfolio and for the second portfolio, optional step 255 of FIG. 8 can be included when identifying documents associated with each classification, and the best predicted classification for each document in both portfolios can be compared. Comparing the best predicted classification for each document may be considered particularly advantageous since an automated machine selects the best probability classification, rather than a human, and there is no ambiguity over how many classifications are allowed per document (a maximum of one classification per document, if the best probability classification is selected).

A portfolio of documents may be associated with an entity in various ways. For example, a portfolio of patents may be associated with a common assignee, or with an assignee and subsidiaries of an assignee. Similarly, a portfolio of documents may be associated with an individual owner, or inventive entity, or group of inventors. One method of using the analysis computer program is to compare portfolios of patent-related documents owned by two companies. The foregoing examples are applicable to other types of documents also. For example, press releases can be associated with an entity in a variety of ways. Press releases could be associated with the company that releases them, they could be associated with a commercial product, they could be associated with the name of a person, or they could be associated with an event.

There are a limitless number of possibilities for the type of content documents used in the training phase, and the type of content documents used in the prediction phase. As described previously, the choices for the training set and prediction set have a profound effect on the quality of the results and the meaning of the results. For example, in the field of patent analysis, one scenario is to train using a large set of patent-related documents that are not associated with any entity in particular, but attempt to broadly describe areas of technology. The model file produced from that training set can then be used to predict classifications for a broad set of patents. The advantage of this is that the model file is widely applicable to any set of patents across any technology areas. In the area of portfolio comparison, however, this isn't necessarily the goal. In the area of portfolio comparison, the goal is to find documents of a competitive portfolio associated with another entity that are similar or related to a company's first portfolio, and to also identify the documents that fall outside the business scope of a company so that those documents receive no further attention. As such, for portfolio comparison, a method of applying the classifier components is to train only on the documents associated with an entity, and then predict on the portfolio of documents associated with another company. Using this technique, it is easy to see which documents of the competitive portfolio are in the scope of the first portfolio and which documents fall outside that scope. As previously described, if a model file is derived from a portfolio associated with an entity, it is also possible to run prediction on the first portfolio associated with an entity and run the prediction on the competitive portfolio associated with another entity, and thus probabilities can be derived for both sets of prediction. By selecting only the highest probability classification, it is possible to compare using no more than one classification per document, which as stated before, has the advantage of avoiding any comparison concerns over how many classifications are allowed or desirable per document.

As important as training and prediction on patent portfolios, is the possibility of training on one type of document and prediction on a different type of document. In particular, it is often desirable to ascertain a relationship between patents and commercial products. As such, one exemplary technique is to train using a patent portfolio, and then to run the prediction phase on product documentation. Any patent that is associated with a particular classification might be applicable to products also predicted to be associated with the same particular classification. Clearly the same analysis program described in FIG. 8 can be used to build up a comparison of product documents with patent-related documents within the same classification, and where there are high bars, an area of possible overlap can be investigated. The opposite is also possible. For example, the training phase may be run using product documentation and the prediction phase can be run using a set of patent-related documents. This technique of training on one set of document types and then predicting on another set of document types in order to see the relationship between them is applicable across all document types. For example, marketing literature, web pages, press releases, academic publications, product documentation, patent-related documents are all document types that may be of particular advantage to compare with each other.

As described in regard to FIG. 8, the count and list of the documents associated with each possible classification can be kept. For example, if the classification schema includes 1.1, 1.1.3 and 1.1.1.4, then a count and list of documents can be created for 1.1, 1.1.3 and for 1.1.1.4 respectively. However, in one embodiment of the invention, a user-defined classification schema included over 1600 possible classifications, and comparison of documents classified using the highest detailed classifications was not desired. As such, it was desirable to only compare the number of documents at the topmost level of the classification schema—i.e. 1, 2, 3, etc. More specifically, all of the documents that were classified with child classifications were rolled up to the parent classification. As also described in regard to FIG. 8, the comparison computer program is able to create roundup statistics using optional step 248 of FIG. 8. The comparison instructions read the classification, and then truncate the classification as necessary before looking up the relevant Count instance. For example, if the comparison software reads 1.1, or 1.1.1, or 1.1.1.3, it can shorten the classification to the most significant digit “1”. This methodology allows for generation of statistics at any level of a user-defined classification schema. For example, comparison analysis software can also generate statistics at the second level by collecting the first two significant digits. One advantage of being able to do the roundup is that the classification predictions do not need to be as accurate. For example, classifications “1.1” and “1.2” both get truncated to “1”, and so even if the automatic classification prediction computer program mistakenly classifies text as being associated with “1.1”, when it should have classified as “1.2”, the roundup statistics for classification “1” are still the same. Another advantage is simplicity, since a user may only wish to see comparisons of portfolios at an overview level.

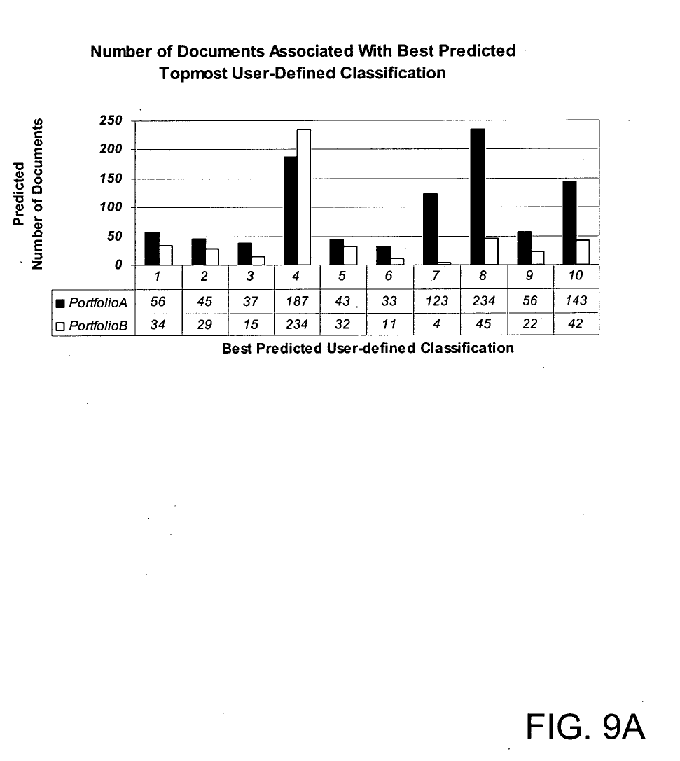

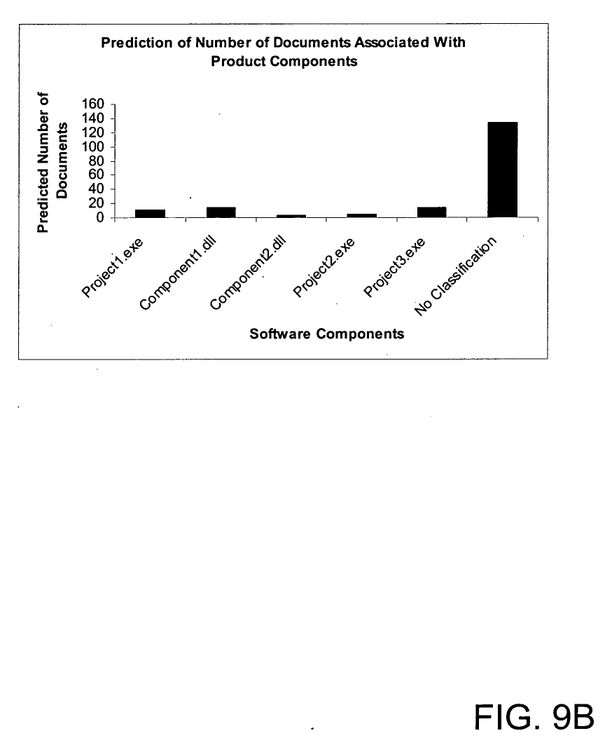

FIG. 9A shows a sample bar chart that can be displayed after the analysis program described in FIG. 8 is run on the custom classifications determined to be associated with documents in Portfolio A and in Portfolio B. The bar chart of FIG. 9A shows the number of documents that are in Portfolio A and predicted to be associated with a topmost custom classification, and similarly, the number of documents in Portfolio B predicted to be associated with a topmost custom classification. Notably, the optional step 255 of FIG. 8 is used to generate the number of documents for both Portfolio A and Portfolio B, so that only the best predicted classification is selected for each document of both portfolios. The chart clearly allows a comparison of the work by two separate entities, in custom classifications that are defined by any user of the present invention. A comparison chart can contain any number of portfolios, and can specify any number of classifications. Additionally, the chart can be formatted as a bar chart, line chart, pie char, 3D chart, as well as other commonly available chart types, and clearly the output of the numbers of documents classified according to each custom classification can be placed into a table in a report, or other textual format, or can be displayed on a monitor.

FIG. 9B shows a sample bar chart that can be displayed after running the analysis program described in FIG. 8 on a portfolio. In the case of FIG. 9B, the user-defined classification schema comprises product components. In the example shown, a model file was created by training the automatic classifier with a portfolio of documents that were classified with product components. As such, the prediction program, when given that model file as an input, has the ability to predict product components associated with documents. The chart of FIG. 9B illustrates a portfolio of documents that are now predicted to be associated with software components of the user-defined schema. Notably, a bar within FIG. 9B is associated with “No Classification”. This is also significant, because the program has identified documents that can be prioritized as not being of as much interest as other documents

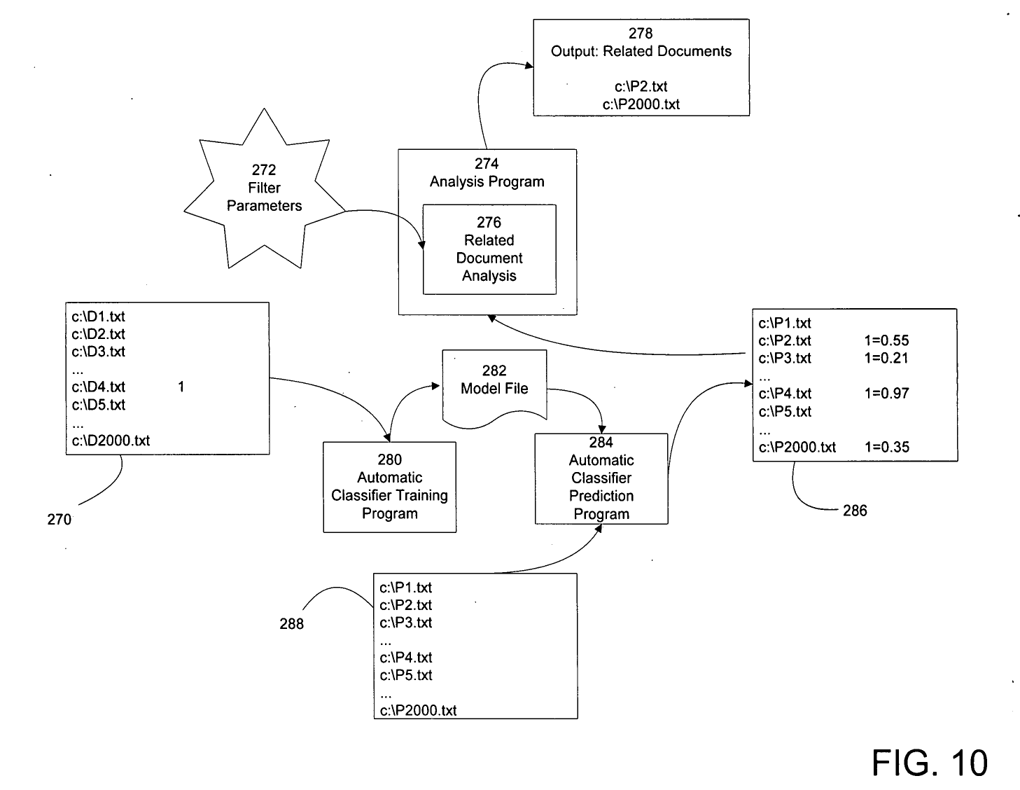

Another aspect of the invention is the ability to analyze a portfolio of documents and find documents related to particular documents of interest, using results from an automatic classifier. For example, one use for this aspect of the invention is the ability of the analysis program to identify possible prior art references to one or more patents. FIG. 10 shows how the components of the invention may be used to find related documents. An input file 270 comprises a list of documents. Of these, one or more documents is classified with a user-defined classification, such as “1” (though, of course, it could be any unique classification identifier). The documents selected for classification are the ones for which all related documents are to be found. The other documents in the input file 270 have no classification associated with them. The input file 270, along with access to the documents themselves (not shown) is given to the classifier training program 280. The classifier training program outputs a model file 282. The model file 282 and another set of documents 288 are then input into an automatic classifier prediction program 284. For this aspect of the invention, the prediction program 284 needs to be able to output the statistical probability of each predicted classification, or any equivalent thereof. The prediction program 284 outputs a list of the documents 286, and also outputs a predicted classification for each document along with its associated probability. In some cases, where a threshold probability is set, a document will not have a classification associated with it in the output file 286. This output file can then be input into the related document analysis software 276, which is a component of the analysis program 274. The related document analysis software 276 is responsible for generating a ranked list of the most related documents 278. To do this, the related document analysis software 276 can optionally use various filter parameters 272. The various filter parameters are discussed in more detail below.

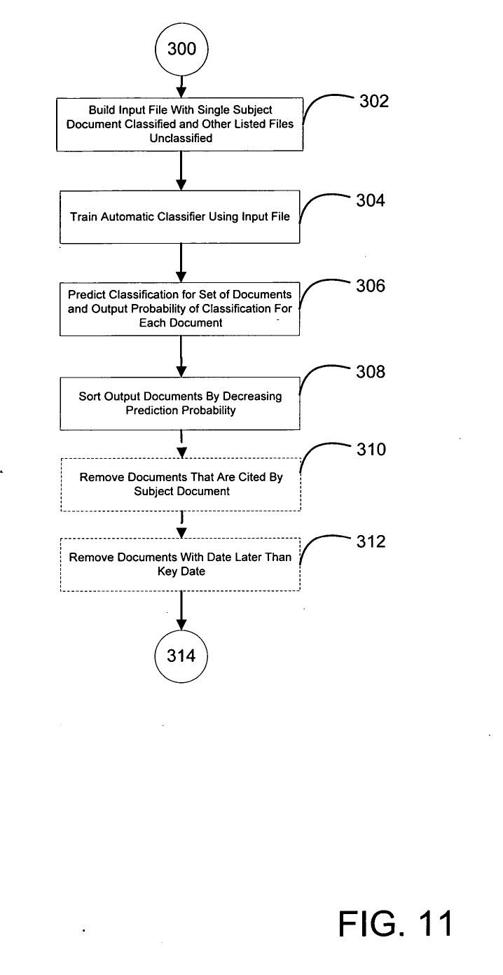

Referring now to FIG. 11, a flow chart is shown that describes the steps for finding and ranking the related documents. The chart starts in state 300, and in step 302 a user of the present invention defines a list of documents. The user places a classification next to the subject documents of interest, and leaves all other documents unclassified. For the training and prediction phases, the user can retrieve the list of documents from a variety of sources. For example, the documents can be retrieved by a keyword search, or from retrieving all of the documents associated with a company or other entity. In one method of finding related documents, the claims from a subject patent are used to create a subject document, and the portfolio of patents from a company are used as the other documents during training. In step 304 the user then trains an automatic classifier program using the input file built with step 302. In step 306, the user predicts the probability of the classification for each document in a second set of documents. For finding related documents, the second set of documents can be the same set of documents that is used in the training step 304, but preferably they are a new set of documents that are deemed to potentially be related to the subject documents. For example, one method of finding the documents to use in the prediction phase can be via keyword search. It is not necessary for the documents that were classified in the training input to be included in the prediction input, because those documents will receive a very high probability of being related. The output of the prediction step 306 is then passed to the related document analysis software. The related document analysis software is able to perform a variety of tasks, some optional based on filter parameters. Still referring to FIG. 11, in step 308, the related document analysis program sorts the documents by decreasing prediction probability. Thus the document that is predicted to be most similar in content is at the top of the list. Optionally, step 310 can be performed to remove documents that are directly cited by the subject documents. This is performed if the goal is to output documents that are not directly cited by the subject documents. Next, in step 312, the related document analysis software can remove documents with any date that is later than a key date specified. The goal of step 312 is to remove any documents that occur later than a date of interest. As one example of the usage of step 312, patents that may be relevant as prior art can be identified, but if their date is later than a priority date associated with a subject patent, they can be removed from further consideration. The flowchart ends with state 314 where the documents remaining after the filtering are output to the user.

Many variations of the algorithm shown in FIG. 11 are possible. The set of documents to use in the training phase, and the set of documents to use in the prediction phase can be varied. For example, patent-related documents, product documentation, academic publications, marketing literature or press releases are just some of the possible document types. Also, referring to FIG. 11, steps 308, 310 and 312 respectively are optional. Thus it is possible to construct an embodiment that includes steps 308 and 310, and not 312, or construct an embodiment that includes steps 310 and 312, and not 308. Indeed, any permutation of steps 308, 310 and 312 is possible.

Yet another aspect of the analysis software is that it can provide detailed citation statistics. By performing citation analysis, it is possible to get a sense of the relative age and applicability of work, by two entities, optionally per classification. Notably, this particular aspect of the invention may be performed using official classifications, such as the USPC or IPC schemas, or by using user-defined classifications that are predicted using tools described earlier.

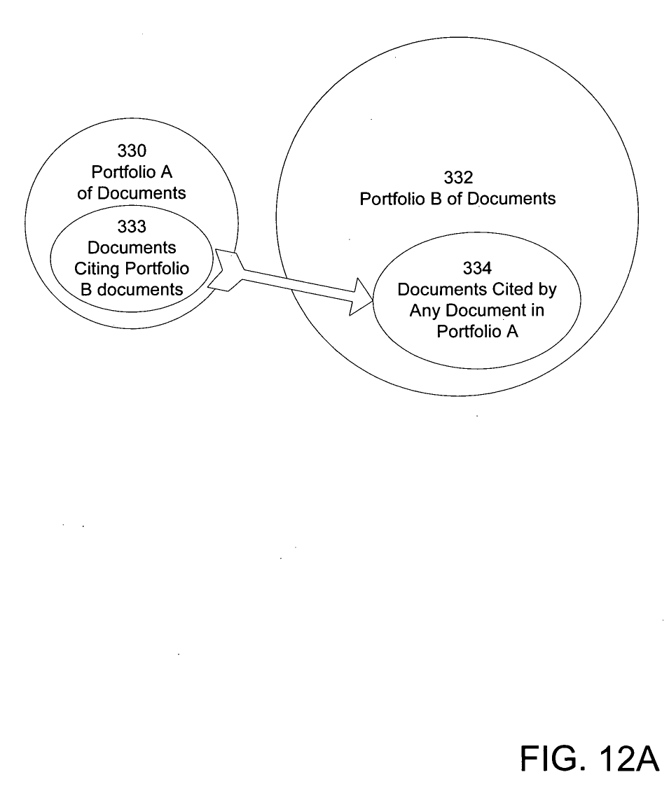

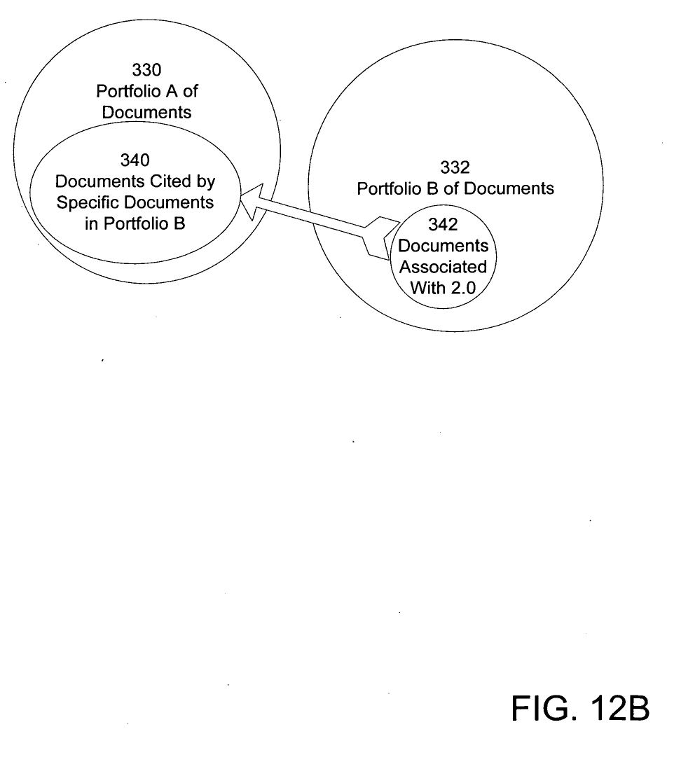

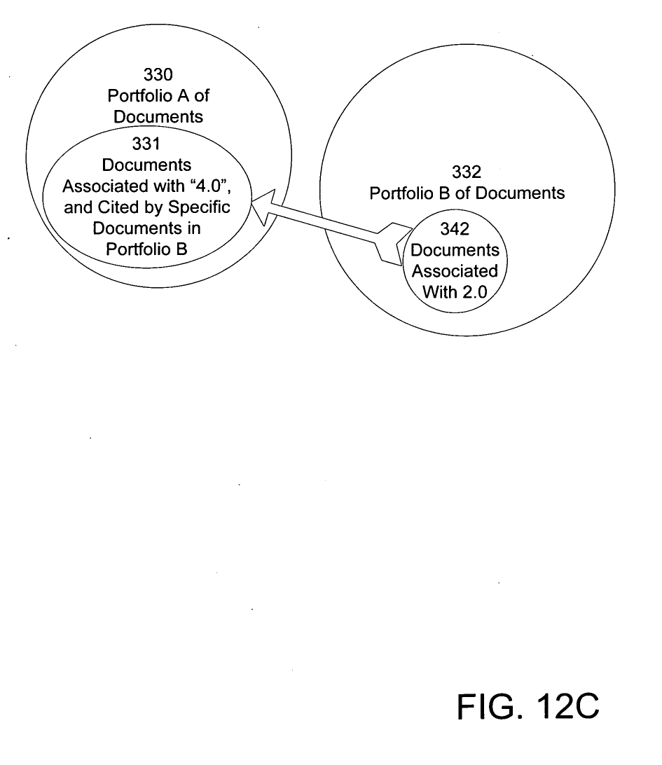

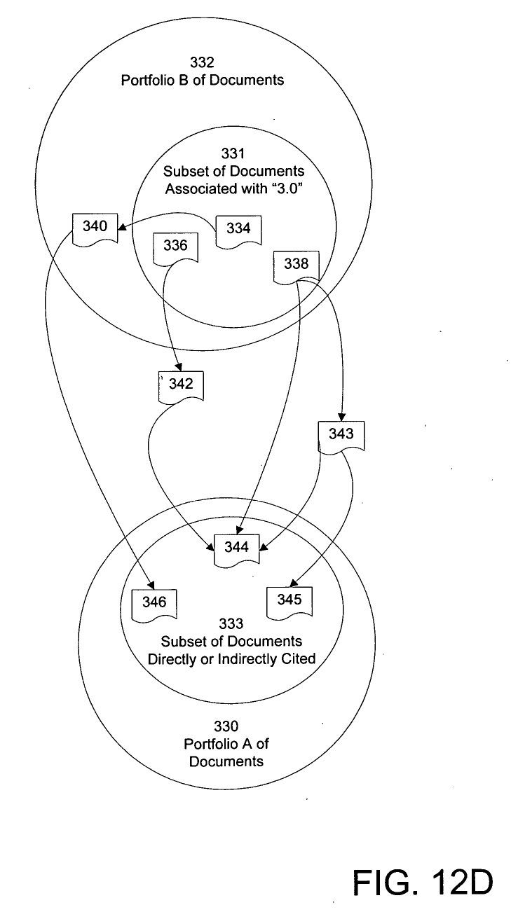

FIG. 12A illustrates a cross-citation analysis technique that may be used between two portfolios of documents. A Portfolio A of documents 330 contains documents. A portfolio B of documents 332 exists, and it also contains documents. FIG. 12A illustrates one example of citation analysis, where all the documents inside of Portfolio A 330 are first selected. A citation statistics program then identifies the set of every document in Portfolio B 334 that is cited by any of the documents in Portfolio A 330.

To be more specific, one embodiment of the citation analysis program iterates through each document in Portfolio A 330, and checks to see if any cited document is also in Portfolio B 332. If the document is both cited by a document in Portfolio A 330 and exists in Portfolio B 332, then it is associated with subset of documents 334. In this case, the result set 334 is the subset of documents cited by any document in Portfolio A 330, that is also in Portfolio B 332.

In another embodiment of the citation analysis program, it is also possible to work in reverse, and find all the documents inside Portfolio A 330 that are citing documents in Portfolio B 332. To do this for the sets illustrated in FIG. 12A, the computer program can iterate through each document in Portfolio B 332, and check for any documents that are in Portfolio A 330, and additionally cite a document in Portfolio B 332. Any documents in Portfolio B that are identified as being cited by a document in Portfolio A 330 are placed into subset 334. The documents identified in Portfolio A 330 as performing the citation are placed into a subset 333, and in this case, the documents performing the citation in 333 form the result.

FIG. 12B illustrates another cross-citation analysis, this time performed from Portfolio B to Portfolio A. In FIG. 12B, the documents in both Portfolio A 330 and Portfolio B 332 are classified according to a classification schema. In the example shown in FIG. 12B, the documents within Portfolio B 332 that are associated with classification “2.038 are identified, and shown as subset 342. A citation statistics analysis program can then identify the set of every document in Portfolio A 330 that is cited by any of the documents in subset 342. To be more specific, the software iterates through each document associated with a particular classification, in subset 342, and checks the cited documents. If it finds a cited document is in Portfolio A 330, it adds the document to a list 340. At the end of the program, when each document in subset 342 has been selected, the list 340 contains every document in Portfolio A that has been cited by a document in subset 342.

As before, it is possible to work in reverse and output the documents that are citing documents, rather than identify cited documents. In the case of FIG. 12B, a computer program can iterate through every document in Portfolio A 330, and identify every document in Portfolio A 330 that is cited by any document in Portfolio B 332. The subset of every document in Portfolio A 330 that is cited by any document in Portfolio B 332 is subset 340 of documents. The computer program can then identify all of the documents that are in Portfolio B 332 and actually perform the citation to documents in subset 340. Of these, it is possible for the computer program to identify the documents that are associated with a classification, such as “2.0”, in this example. The latter subset of documents is subset 342. Thus the computer program, in this instance, starts with the documents in Portfolio A 330 and identifies every document in Portfolio B 332, that cites a document in Portfolio A 330, and is classified by a particular classification “2.0”, and this forms subset 342.

A citation computer program may perform the cross-citation analysis for any or all classifications in any portfolio. The classifications for this use of the invention may be USPC, IPC or user-defined classifications. Additionally, the step of associating cited documents with classifications can be performed either before or after identifying cited (or citing) documents. In the latter case, once all the citation analysis is performed without regard to classification, the cited documents are then grouped according to classification so that it can be known how many of the documents in Portfolio A 330 that are cited by documents in Portfolio B 332 are associated with a particular classification.

The foregoing description has focused on the method concerning identification of documents associated with a classification, and then identifying any documents in another portfolio that are cited. Of equal interest is the case where documents that are being cited are associated with classifications. For example, in one method of citation analysis, a first portfolio of documents can be classified according to a user-defined classification schema or an official classification schema (such as the USPC or IPC schemas). A second portfolio of documents can be selected, and all of the documents in the first portfolio that are directly cited by any of the documents in the second portfolio can be identified. At this stage, it is possible to further identify the cited documents within the first portfolio that are associated with any particular classification. The classification of the documents in the first portfolio can take place either before or after the identification of the cited documents. Thus, in this method of citation analysis, every document that is cited by any document in another portfolio, is within a specific portfolio, and associated with a particular classification has been identified. It is also possible to identify all the classifications of every document within a specific portfolio, wherein the documents are cited by any other document in another portfolio.

The method of identifying documents that are cited by documents in another portfolio, and are associated with a classification can be taken a step further. In particular, two portfolios of documents can be classified according to a user-defined classification schema or an official schema (such as USPC, IPC, or other schema typically used in a field of endeavor). With documents inside both portfolios classified, it is possible to identify every document inside a first portfolio, associated with a first classification, that is cited by any document that is classified according to a second classification, and is contained inside a second portfolio. FIG. 12C shows the results from performing the latter method. In FIG. 12C, a Portfolio A of documents 330 and a Portfolio B of documents 332 are illustrated. The documents of Portfolio A 330 and Portfolio B 332 are classified according to a user-defined classification schema. Next, in the example shown, the documents associated with classification “2.0” and inside Portfolio B are selected as subset 342. All of the documents cited from documents in subset 342 are identified, and of these documents, the ones that are inside Portfolio A 330 and that are associated with “4.0” are identified as subset 331 of documents.

As in the previous case, a method can also be specified to identify the subset of documents, associated with a first classification, that are citing documents in another portfolio, associated with a second classification. Referring still to FIG. 12C, the method to identify the documents that are citing documents, and are in Portfolio B, and are associated with classification “2.0” would start with iteration through each document in Portfolio A 330. In the example shown in FIG. 12C, the method would iterate through each document in Portfolio A 330 and identify the first subset of documents that are associated with “4.0”, and identify which of the documents in the first subset are cited by any document also in Portfolio B 332, and place those results in a second subset. The computer program can then determine which documents in the second subset are associated with a particular classification, such as “2.0”, and the final result is subset 342 which contains the documents in Portfolio B 332 that are associated with a particular classification and citing particular documents in Portfolio A 330 that are also associated with a classification.

Another embodiment of the citation analysis software is able to identify cited documents recursively, and determine all of the documents in another portfolio that are cited either directly or indirectly by a subset of documents in a competitive portfolio, up to a maximum recursive level of citation, or up to a maximum number of documents that have been examined. A maximum level of recursion, or maximum number of documents, can be specified by the user, or coded into the software. In particular, for any given document, the software is able to iterate through all the list of cited documents of that document, and then iterate through all of the cited documents of each cited document. The recursive citation analysis can occur up to any level of citation. For the sake of efficiency, retrieval and parsing of a document may not be necessary if the citation information for documents specifies that a document is not in either of the portfolios and if the last level of recursion has been reached.

FIG. 12D shows two competitive portfolios of documents, Portfolio A 330 and Portfolio B 332. Each document in both portfolios has been classified according to a user-defined classification schema. In the example depicted in FIG. 12D, the citation analysis software identifies documents 334, 336 and 338 as being associated with classification “3.0”, and as part of Portfolio B 332. The goal of the software citation analysis program, in the example shown in FIG. 12D, is to identify every document in Portfolio A, that is cited either directly or indirectly by documents in a subset of Portfolio B, wherein the documents in the subset are associated with a particular classification, using a user-defined maximum recursion level.

In the example, the software analysis program first identifies all of the documents in Portfolio B, and that are associated with user-defined classification “3.0”. In the example shown in FIG. 12D, it finds documents 334, 336 and 338 respectively. The program then selects the first level of cited documents for each document identified in subset 331. For document 334, it identifies document 340. For document 336, it identifies document 342, and for document 338 it identifies document 343 and document 344. Since, in this example, the program continues up to a recursion level of two, the program also identifies the next level of cited documents. The analysis program examines the citations of documents 340, 342, 343 and 344. Document 340 cites document 346. Document 342 cites document 344. Document 343 cites documents 344 and 345 respectively. At this stage, citation information for documents 340, 342, 343, 344, 345 and 346 have been identified via recursive citation analysis, and the maximum recursion level of two (specified by the user in this example) has been reached, so identification of documents stops. Finally, the analysis program checks which of the identified documents are in Portfolio A 330, and finds that documents 344, 345 and 346 are in Portfolio A 330, so those documents form the result subset 333. The output of the program can comprise the list of documents found in Portfolio A 330 via recursive analysis, subset 333, and/or the count of the number of documents in subset 333. Citation information may be identified at a time other than during the analysis of the particular portfolio, such as a method in which all citation information for the subset of documents is stored and cached before analysis begins.

The foregoing description has described how to identify the documents in one portfolio that are cited, directly or indirectly, from documents in another portfolio that are associated with a particular classification. It is also possible to identify the documents that are in a first portfolio, associated with a classification, and are citing, directly or indirectly, documents in a second portfolio. Referring to the example shown in FIG. 12D, and again assuming a maximum recursion level of two is specified, a computer program can iterate through all of the documents in Portfolio A 330, and find all of the documents that cite each document in Portfolio A 330. In the case of FIG. 12D, documents 346, 344, and 345 are cited by documents 340, 342, 338 and 343. The computer program can then identify all of the documents that are cited by those latter documents, and identifies documents 334, 336, and 338. At this stage, the computer program has reached the maximum specified level of recursion, and all the documents identified during the traversal can be checked for conditions. In this case, documents identified from the recursive traversal include 340, 342, 338, 343, 334, and 336. The computer program then checks which of these documents are in Portfolio B 332 and are associated with a particular classification, such as “3.0” in the example figure. Of these the computer program identifies documents 336, 334 and 338. These three documents form the result set in this example.

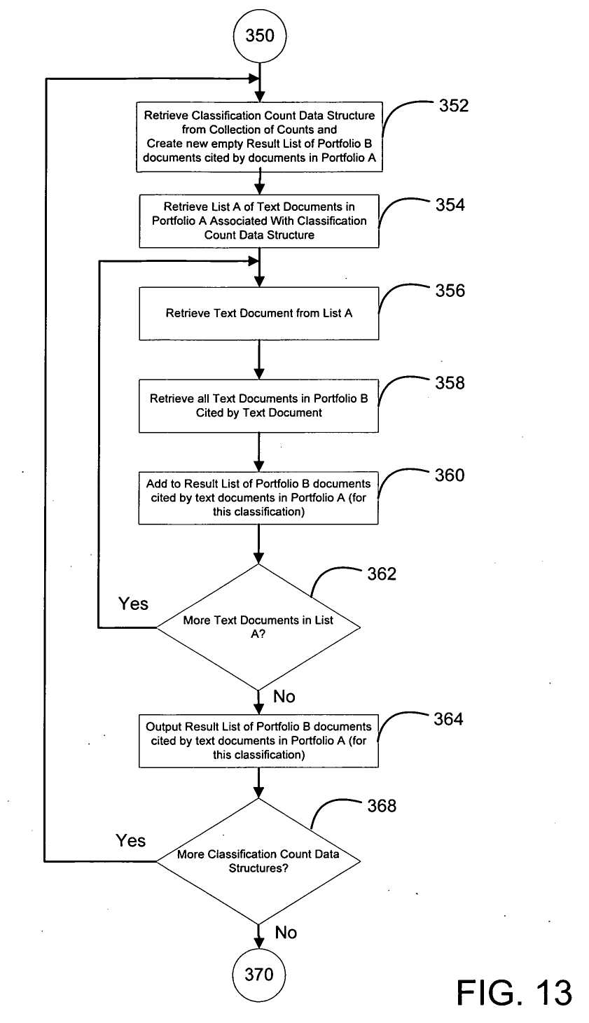

FIG. 13 further clarifies an exemplary algorithm for identifying the documents in Portfolio B, cited by documents in Portfolio A, for each classification in a user-defined classification schema. The starting point 350 indicates that the classifications from the user-defined classification schema have been obtained for both portfolios, and that an array of Count instances exist, wherein each instance of the Count instance maintains documents within a portfolio associated with each classification. The description concerning FIG. 8 details obtaining the Count instances for starting point 350. In this example, the classification results for Portfolio A are read by the computer program described in FIG. 8. As such, the Count instances obtained by the computer program of FIG. 8 hold lists of documents in Portfolio A that are associated with each classification. The variations of obtaining the Count instances that were described in conjunction with FIG. 8 are applicable here also. As one example, when obtaining Count instances, a user can elect to only obtain instances for the topmost classifications, and can employ optional step 248 of FIG. 8 in order to roundup statistics for lower child classifications into their parent classifications.

The embodiment in FIG. 13 can be used whether the classifications were derived from humans actually assigning the classifications, or were derived from a prediction program that predicts the classifications for documents within a portfolio. An iterative loop starts before step 352, and the first Count instance is obtained from the collection of Count instances using the first classification in the classification schema. Also, in step 352 a new empty result list to hold the Portfolio B documents that are cited by documents, associated with a classification, in Portfolio A is created. The new list starts off with zero members. In step 354, a list A of portfolio documents associated with the first Count instance is retrieved. An inner iterative loop begins before step 356, and the first document within the list A is identified. In step 358, the citation analysis software looks up all of the documents that are cited by the document identified in List A, wherein those documents are also in Portfolio B. In one embodiment, for patent citation analysis, this can be done by examining the Citations section of patent-related document, and looking up all the patent numbers within the Citations that also exist in the other portfolio. In another embodiment, the citation information has been examined and cached before the analysis process begins. In step 360 the list of documents that are in Portfolio B and cited by the document are added to the result list. In step 362 a conditional statement tests if there are more documents in list A. If there are, it loops back to before step 356 and step 356 then identifies the next document in list A, and then performs steps 356, 358 and 360 for that document. If there are no more documents in List A, then the output result list of Portfolio B documents cited by documents in Portfolio A, for that particular classification, is complete. Step 364 outputs the result list containing every document in portfolio B cited by any document in portfolio A that is also classified with the particular classification held inside the Count instance. The output could be in a file format, it could be displayed, it could be in a report or chart, or the output could be any other equivalent computer related means for output. After the result list has been output in step 364, a conditional statement tests if there are more classification Count instances in the collection of Counts, and if there are, it iteratively loops back to before step 352 wherein the next Count instance is retrieved, so that the citation analysis for the classification associated with that Count instance can be undertaken. If there are no more classification instances the program ends in 370.

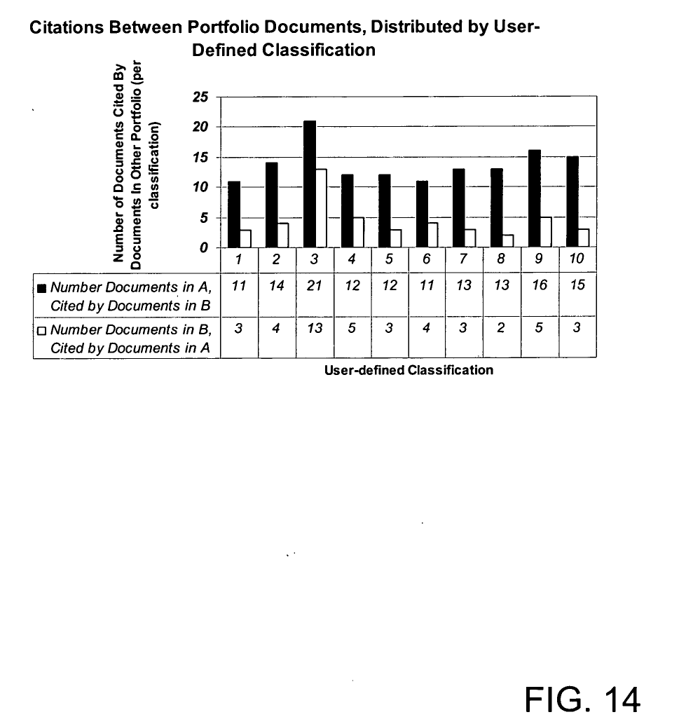

FIG. 14 illustrates a bar chart that depicts sample results from a cross citation analysis described by the algorithm in FIG. 13. On the horizontal axis, the topmost classifications from a user-defined classification schema are shown. On the vertical axis, the number of documents cited by documents in the other portfolio (per classification) is shown. The results from the program described with FIG. 13 are utilized to create the bar chart. Specifically, each dark bar shows the number of documents in Portfolio A that are cited by any documents within a subset of documents in Portfolio B, wherein the documents of the subset are associated with a particular classification. Each light bar shows the number of documents in Portfolio B that are cited by a subset of documents in Portfolio A, wherein the documents of the subset are associated with a particular classification.

The embodiments of the citation analysis software described above can produce different types of statistics and results. For example, it is possible just to produce the number of documents cited by specific documents associated with a classification in another portfolio, similar to FIG. 14, or it is equally possible to output the lists of documents cited by specific documents associated with a classification in the other portfolio. The lists of documents allow a user to view which documents are deemed related or relevant to a topic or area of interest, and that are also in a competitive portfolio. The number of documents and lists of documents can be displayed to the user, or formatted into reports, as well placed into a variety of chart formats such as bar charts, pie charts, line charts, scatter plots, and any equivalents thereof.

Some embodiments of the present invention have been described as software modules that run on a single computer. A person of ordinary skill in the art realizes that storage devices utilized to store program instructions can be distributed across a network. For example a remote computer may store an example of the process described as software. A local or terminal computer may access the remote computer and download a part or all of the software to run the program. Alternatively the local computer may download pieces of the software as needed, or distributively process by executing some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

We claim:

1. A computer readable medium having one or more executable instructions that, when read, cause one or more processors to:
identify a first set of two or more documents having citations therein;
identify a second set of one or more documents; and
identify every document in the second set that is cited by any of the documents in the first set.

2. A computer readable medium according to claim 1, wherein one or more documents in the second set of documents have citations therein; and the one or more instructions cause the one or more processors to further:
identify every document in the first set that is cited by any of the documents in the second set.

3. A computer readable medium according to claim 1, comprising one or more instructions that cause the one or more processors to further:
traverse the citations of the first set of documents recursively;
identify citation information for the first set recursive citation traversal; and
identify documents in the second set that are also cited by the citation information identified during the recursive traversal.

4. A computer readable medium according to claim 1, wherein the first set of documents comprises patent-related documents.

5. A computer readable medium according to claim 3, wherein one or more documents in the second set of documents have citations therein; and the one or more instructions cause the one or more processors to further:
traverse the citations of the second set of documents recursively;
identify citation information for the second set recursive citation traversal; and
identify documents in the first set that are also cited by the citation information identified during the recursive traversal.

6. A computer readable medium according to claim 1, wherein one or more documents in the first set of documents are associated with one or more classifications; and the one or more instructions cause the one or more processors to further:
for each document in the second set identified as cited by any of the documents in the first set, identifying any classifications associated with the document.

7. A computer readable medium according to claim 2, wherein one or more documents in the second set of documents is associated with one or more classifications; and the one or more instructions cause the one or more processors to further:
for each document in the first set identified as cited by any of the documents in the second set, identifying any classifications associated with the document.

8. A computer readable medium according to claim 6, wherein the classifications are predicted by an automatic classifier.

9. A computer readable medium according to claim 6, wherein a classifier based on Support Vector Machine technology is utilized to predict the classifications for the first set of documents.

10. A method, comprising:
identifying a first set of two or more documents, wherein one or more
documents in the first set has citations therein;
identifying a second set of one or more documents; and
identifying every document in a second set that cites any of the documents in the first set.

11. The method according to claim 10, wherein one or more documents in the second set of documents have citations therein; and the method further comprises:
identifying documents in the first set that cite any of the documents in the second set.

12. A method according to claim 10, further comprising:
generating a first subset of one or more documents in the first set of documents, wherein each document in the first subset is associated with a classification; and
identifying documents within the second set of documents that cite any of the documents in the first subset.

13. A method according to claim 12, wherein a text classifier predicts the classification.

14. A computer readable medium having one or more executable instructions that, when read, cause one or more processors to:
identify a first set of documents that are associated with one or more classifications;
predict classifications for one or more documents in a second set of documents;
generate a first subset of one or more documents in the second set of documents that is associated with a particular classification; and
identify a result subset of documents in the first set that are cited by any of the documents in the first subset.

15. A computer readable medium according to claim 14, comprising one or more instructions that cause the one or more processors to further:
display a report containing the identified documents in the result subset.

16. A computer readable medium according to claim 14, comprising one or more instructions that cause the one or more processors to further:
display a chart containing the number of identified documents in the result subset.

17. A computer readable medium according to claim 14 wherein the particular classification is associated with a product category.

18. A computer readable medium according to claim 14 wherein the particular classification is associated with a commercial product.

19. A computer readable medium according to claim 14 wherein the first set of documents comprises patent-related documents.

20. A computer readable medium according to claim 14 wherein the second set of documents comprises any one of academic publications, press releases, product documentation or marketing literature.
